(19) United States
(12) Patent Application Publication
(10) Pub. No.: US 2022/0340487 A1
(43) Pub. Date: Oct. 27, 2022

(54) ACID-RESISTANT INORGANIC COMPOSITE MATERIAL AND METHOD OF FORMING SAME

(71) Applicant: The Regents of the University of Colorado, a body corporate, Denver, CO (US)

(72) Inventors: Wilfred V. Srubar, III, Boulder, CO (US); Juan Pablo Gevaudan, Austin, TX (US)

(73) Assignee: The Regents of the University of Colorado, a body cor, Denver, CO (US)

(21) Appl. No.: 17/635,320

(22) PCT Filed: Aug. 11, 2020
(86) PCT No.: PCT/US2020/045808

§ 371 Date: Feb. 14, 2022

Related U.S. Application Data
(60) Provisional application No. 62/885,713, filed on Aug. 12, 2019.
(60) Provisional application No. 62/914,965, filed on Oct. 14, 2019.

(51) Int. Cl. C04B 12/00

(52) U.S. Cl. CPC C04B 12/005; C04B 2111/00215

(57) ABSTRACT

Acid-resistant composite materials and methods of forming acid resistant composite materials are disclosed. The acid resistant composite materials can include one or more monovalent, divalent, or polyvalent cationic metals. The acid resistant composite materials can be used, for example, in the formation of concreate or as a coating for concrete.

### CROSS REFERENCE TO RELATED APPLICATIONS

This application claims the benefit of U.S. Provisional Application Ser. No. 62/885,713, filed on Aug. 12, 2019, and entitled Acid-Resistant Inorganic Composite, and of U.S. Provisional Application Ser. No. 62/914,965, filed on Oct. 14, 2019, and entitled Acid-Resistant Inorganic Composite Material and Method of Forming Same, the contents of which are hereby incorporated herein by reference to the extent such contents do not conflict with the present disclosure.

### GOVERNMENT LICENSE RIGHTS

This invention was made with government support under grant number 1604457 awarded by the National Science Foundation. The government has certain rights in the invention.

### FIELD OF THE DISCLOSURE

The present disclosure generally relates to composite materials. More particularly, examples of the disclosure relate to acid or corrosion-resistant materials suitable for use in cement and concrete.

### BACKGROUND OF THE DISCLOSURE

Cement and concrete are used in a variety of applications, including significant infrastructure, such as roads and sewers. Microbial-induced concrete corrosion (MICC) continues to challenge the underground conduit networks that make up an important part of urban infrastructure. One of the most aggressive and ubiquitous forms of MICC stems from the biologically mediated production of sulfuric acid in sewers. Population centers around the world share this serious and growing problem. In the United States, local governments spend approximately $50 billion in the construction, operation, and maintenance of over 800,000 miles of sewers annually. In order to rehabilitate and expand the wastewater infrastructure, the United States Environmental Protection Agency estimates that $271 billion is needed over the next generation, a substantial fraction of which is dedicated to directly respond to widespread biogenic corrosion that is significantly reducing the service life of buried sewers. Sewer service life reductions result from the fact that conventional ordinary Portland cement (OPC) concrete is rapidly compromised by biogenic sulfuric acid attack, producing gypsum and amorphous silica from the cementitious binder. The non-load bearing quality of gypsum leads to severe structural deterioration and, ultimately, pipe failure.

Mitigation strategies for microbial-induced concrete corrosion are often short-term, relatively expensive, and site-limited. In order to provide in-situ acid protection for OPC concrete sewers, operators have used surface coatings and linings, concrete binder additives, and, even, antimicrobial additives. As an example, a popular mitigation practice includes the use of acid resistant, cured-in-place resins. While seemingly effective in resisting acid exposure, the associated cost of these materials is high ($390-900 per linear meter), they require special curing conditions, and may not prevent corrosive gas infiltration, seriously compromising the effectiveness of this mitigation practice. Further, with the exception of antimicrobial additives, these mitigation strategies do not address one of the underlying causes of MICC in these environments: acidophilic microbial growth. Accordingly, improved acid-resistant composite materials are desired.

Any discussion of problems and solutions set forth in this section has been included in this disclosure solely for the purpose of providing a context for the present disclosure and should not be taken as an admission that any or all of the discussion was known at the time the invention was made.

### SUMMARY OF THE DISCLOSURE

This summary is provided to introduce a selection of concepts. This summary is not intended to necessarily identify key features or essential features of the claimed subject matter, nor is it intended to be used to limit the scope of the claimed subject matter.

Various embodiments of the present disclosure relate to acid-resistant composite materials. The acid-resistant composite materials can be used in the formation of, for example, cement, concrete, or coatings for, for example, concrete.

In accordance with exemplary embodiments of the disclosure, an acid-resistant composite material includes greater than 0% to about 75%, or about 40% to about 60% SiO₂; greater than 0% to about 75%, or about 30% to about 50% Al₂O₃; about 1% to about 25% or about 1% to about 20% CaO (or no added calcium oxide); greater than 0% to about 25%, or about 0.1% to about 10%, or about 1% to about 10% one or more monovalent, divalent, or polyvalent cationic metals; and greater than 0% to about 25%, or about 0.1% to about 10% , or about 1% to about 10% one or more other inorganic materials. The one or more other inorganic materials can include soluble and/or insoluble metal (e.g., alkali) salts. The one or more monovalent, divalent, or polyvalent cationic metals can include one or more group 2 and/or one or more transition metals. For example, the one or more monovalent, divalent, or polyvalent cationic metals can be selected from one or more group 2 and/or group 8-11 metals. By way of particular examples, one or more monovalent, divalent, or polyvalent cationic metals can be selected from the group consisting of calcium, titanium, lithium, chromium, copper, cobalt, iron, and magnesium. The acid-resistant composite material can include a plurality of the one or more monovalent, divalent, or polyvalent cationic metals. In accordance with various aspects of these embodiments, a ratio of silicon to aluminum in the acid-resistant composite material can be about 0.75 to about 3.0, or about 1.0 to about 2.0. A ratio of sodium to aluminum in the acid-resistant composite material can be about 0.8, or about 0.9 to about 1.4, or about 0.8 to about 1.2. In accordance with further examples of the disclosure, the one or more aluminosilicate precursors comprise a synthetic aluminosilicate precursor.

In accordance with further embodiments of the disclosure, a method of forming an acid-resistant composite material includes the steps of dissolving one or more alkaline metal salts in a solution; and adding the solution to one or more aluminosilicate precursors and optionally other minerals/materials (such as those described herein) to form a mixture. The one or more aluminosilicate precursors comprise one or more of a synthetic aluminosilicate precursor, metakaolin, fly ash, slag, pumice, basalt, glass, or other natural pozzolan, and other materials noted herein. The method can optionally include filtering the mixture. The method can also include a step of drying the mixture to form a dried material. The dried material can be ground using a step of grinding. Exemplary methods can further include adding an alkali additive to one or more of the mixtures and the dried mixture. The alkali additive can include, for example, one of more of sodium silicate, sodium hydroxide, potassium hydroxide, or sodium carbonate or other (e.g., alkali) salts, including salts including one or more of OH, Cl, or Br. The step of adding an alkali additive to one or more of the mixture and the dried material can comprise adding a solid and/or a liquid.

These and other embodiments will become readily apparent to those skilled in the art from the following detailed description of certain embodiments having reference to the figures; the disclosure not being limited to any particular embodiment(s) disclosed.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates that low-calcium aluminosilicates (i.e., fly ash and calcined clays) produce main cementitious binders such as C-N-A-S-H or N-A-S-H via (III) gelation and precipitation.

FIG. 2 illustrates acid degradation mechanism of a low-calcium AAC in the presence of sulfuric (diprotic) acid. Note that complete dissociation of sulfuric acid's second proton can occur at pH values of 4.0.

FIG. 3 illustrates surface area-normalized daily elemental leaching (mg/cm²) in deionized water (DI water) and sulfuric acid (Acid) over seven days for Control (□), Control+Cu (○), and Control+Cu/Co (Δ). Error bars represent the standard deviation of three replicates.

FIG. 4 illustrates elemental leaching from pulverized AAC formulations in response to increasing acid concentration (eq H₃O+/kg AAC) for Control (□), Control+Cu (○), and Control+Cu/Co (Δ) samples.

FIG. 5 illustrates XRD patterns for (a) dehydrated samples, and samples exposed to: (b) ambient conditions (22° C. and 30% relative humidity), (c) deionized water, and (d) sulfuric acid. S: srebrodolskite, G: gypsum, H: calcium sulfate hydrate, C: calcium silicate hydrate (C—S—H), W: wüstite, Q: quartz, M: merwinite, and O: corundum.

FIG. 6 illustrates XRD patterns for samples exposed to increasing concentrations of sulfuric acid: (a) 0 eq, (b) 4 eq, (c) 6 eq, and (d) 8 eq. S: srebrodolskite, G: gypsum, H: calcium sulfate hydrate, C: calcium silicate hydrate (C—S—H), W: wüstite, Q: quartz, M: merwinite, O: corundum.

FIG. 7 illustrates permeable porosities after seven days of exposure in deionized water and sulfuric acid.

FIG. 8 illustrates corrosion-layer depth thickness for all samples with their respective thickness of weak corrosion layer after seven days of exposure in sulfuric acid (n=3).

FIG. 9 illustrates elemental mapping of Control, Control+Cu, Control+Cu/Co samples when (a) unexposed to acid and (b) after seven days of sulfuric acid exposure. Acid intrusion direction is from right to left. Scale bar=1 mm.

FIG. 10 illustrates a number of silicon and aluminum atoms at each EMPA data point for (a) Control, (b) Control+Cu, (c) Control+Cu/Co samples before and after acid exposure. Cross section of lines within each plot indicate a Si:Al ratio of 2.0.

FIG. 11 illustrates a proposed mechanism of the acid degradation of low-calcium AACs.

FIG. 12 illustrates exemplary suitable cations for use in accordance with examples of the disclosure.

FIG. 13 illustrates mineralogy (i) and Fourier-transform infrared (FTIR) spectroscopy (ii) of all samples. In panel (i), F=faujasite (Na_{2.06}Al₂Si_{3.8}O_{11.63}.8H₂O); H=hematite (Fe₂O₃); and, C=Corundum (Al₂O₃).

FIG. 14 illustrates acid exposed mineralogy (i) and Fourier-transform infrared (FTIR) spectroscopy (ii) of all samples. In panel (i) the “F” indicates the presence of faujasite (Na_{2.06}Al₂Si_{3.8}O_{11.63}.8₂O); “H” indicates the presence of hematite (Fe₂O₃); and, “C” indicates the presence of corundum (Al₂O₃).

FIG. 15 illustrates normalized elemental leaching upon acid exposure for sample formulations.

FIG. 16 illustrates compressive strength of exemplary compositions. * Denotes statistically significant difference in the sample mean.

FIG. 17 illustrates Energy Dispersive Spectroscopy (EDS) data on the chemical composition of geopolymer materials with hematite unexposed (⋅, [symbol] ) and exposed to sulfuric acid (⋅, - - -). Lorentzian curve fittings were used to simulate the distribution of chemical composition data.

FIG. 18 illustrates an acid degradation mechanism of a N-A-S-H binder without (A) and with (B) hematite for the first proton dissociated from sulfuric acid. For illustration purposes, the iron cationic species is not specified, and hematite is assumed to dissolve into a ferric ion (Fe+3).

FIG. 19 illustrates visual evidence of a sulfuric acid attack on Ca-free AACs for non-supplemented samples (control) and supplemented samples with brucite (control+Mg).

FIG. 20 illustrates normalized elemental leaching for (A) Low Na:Al=0.86 and (B) High Na:Al=1.39 sample formulations. Data show elemental concentrations in the leachate after the first and second acid equilibrium exposure cycles. Error bars represent one standard deviation.

FIG. 21 illustrates mineralogy of AAC samples without and with brucite before and after acid exposure. Symbols correspond to mineral phases identified as follows: “F” indicates the presence of faujasite-Na (Na_{2.06}Al₂Si_{3.8}O_{11.63}.8H₂O); “B” indicates the presence of brucite (Mg(OH)₂); and, “C” indicates the presence of corundum (Al₂O₃), which was used as an internal standard.

FIG. 22 illustrates equilibrium pH of sulfuric acid solutions for samples without and with brucite. Data show pH of the leachate after the first and second acid equilibrium exposure cycles.

FIG. 23 illustrates distribution and mean atomic Mg:Al ratio of Control Low+Mg (Na:Al=0.86) and Control High+Mg (Na:Al=1.39) AAC samples before and after acid exposure.

FIG. 24 illustrates μ-CT non-connected porosities of AAC samples before and after the first sulfuric acid exposure (pH of 2.0±0.07).

FIG. 25 illustrates nano-scale porosity characterization of samples without and with brucite addition before acid exposure and after sulfuric acid exposure (pH of 2.0±0.07).

FIG. 26 illustrates acid resistance of compositions in accordance with examples of the disclosure.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION OF EXEMPLARY EMBODIMENTS OF THE DISCLOSURE

The description of exemplary embodiments provided below is merely exemplary and is intended for purposes of illustration only; the following description is not intended to limit the scope of the disclosure or the claims. Moreover, recitation of multiple embodiments having stated features is not intended to exclude other embodiments having additional features or other embodiments incorporating different combinations of the stated features.

The present disclosure generally relates to acid-resistant composite materials and to methods of forming and using the acid-resistant composite materials.

An acid-resistant inorganic composite material may be made from an aluminosilicate source, such as metakaolin. The material may have inorganic particles, such as magnesium hydroxide and/or iron hydroxides, that may be incorporated to aid in the acid resistance. The result is a material having superlative acid resistance compared to traditional cementitious materials.

Acid-resistant inorganic composite materials described herein may be of particular interest for use in sewer infrastructure. There is a high level of sulfuric acid production in sewers; this acid dissolves regular cement. To mitigate this issue, polymer linings have been applied or sacrificial cementitious layers have been used. These linings and layers are only temporary, and they do not last the entire lifetime of the sewer system. Other applications for acid-resistant inorganic composite material as described herein can also be imagined—e.g., where high acid resistance is needed, such as battery technologies, mine drainage, and the like.

Alkali-activated cements (AACs) are alternative cements with the potential to counter durability concerns associated with the use of ordinary Portland cement (OPC). As a result of their superior durability, AACs may be used as material solutions to microbial-induced concrete corrosion—a pervasive durability challenge concerning the acid degradation of wastewater infrastructure. Metals (e.g., group 2 and transition metals/metal salts as described herein) improve the acid resistance of AACs by decreasing the deleterious effects of hydronium ions (H₃O⁺), which penetrate past the visually observable corrosion layer and induce cationic exchange, resulting in both electrophilic degradation of the Si—O—Al bonds and beneficial cationic dissolution of minerals. Metal mineral admixtures can improve AAC acid resistance by increasing both the micro-sized porosity and producing chemical microstructural changes to both the Si:Fe and Fe:Al ratios. Light-metal (e.g., group 2 metals) mineral admixtures improve AAC acid resistance by increasing both the, e.g., Mg:Al atomic ratio and the pH buffering capacity of the material, while decreasing both micro- and nano-scale porosity changes.

The customary use of ordinary Portland cement (OPC) concrete has resulted in its inappropriate application for unique infrastructure challenges. For example, concrete slabs in rocket launch pads necessitate lining with refractory or heat-resistant materials (i.e., refractory bricks or fire suppressant coatings) because when OPC concrete is subjected to high temperatures (i.e., fire) its deterioration may result in explosive spalling and reductions in compressive strength. Another example is the unprecedented and deleterious biogenic production of sulfuric acid within sewer infrastructure, which has resulted in reductions in service life. These poor durability and unexpected service-life reductions of OPC concrete are often associated with its calcium-rich cement chemistry. While calcium provides beneficial mechanical properties, oftentimes calcium is the culprit for its durability shortcomings. In acid, deterioration results from both an electrophilic attack on the calcium-based binder and reaction of the conjugate base with soluble calcium forming gypsum, ettringite, or calcium acetate, depending on the acid (e.g., acetic acid, sulfuric acid).

In addition, OPC production is a carbon- and energy-intensive process. The calcination of raw materials alone to produce OPC accounts for 4% of the global CO₂ emissions. The emissions associated with the production of OPC can be divided into two categories: (1) process and (2) energy emissions. Process emissions, resulting from the calcination of raw materials, produces CO₂ on the order of 1.47±0.11 Gt in 2016. Energy emissions are those associated with the combustion of fossil fuels to calcine the raw materials to well over 1000° C. These emissions are accounted differently, depending on the reliance of fossil fuels by individual cement producers. Further exacerbating the environmental impacts of OPC, the demand for cement and concrete is expected to increase due to increasing global population and urbanization patterns. As a result, global cement production is expected to grow by 12-23% by 2050 from the current level.

Viable alternative construction materials are needed in order to circumvent both durability and sustainability issues associated with OPC concrete. As previously discussed, in unique infrastructure challenges, the use of OPC concrete has resulted in the use of additional materials and unexpected reductions of service life. In 2018, the Cement Sustainability Initiative (CSI), an organization formed by a global consortium of leading cement producers, and the International Energy Agency released a technology roadmap for a low-carbon transition of the cement industry. In this report, alternative construction materials are identified as potential options to lower the CO₂ emissions of the industry. Yet, standardization, complete lifecycle assessments, and durability optimization are remaining challenges for these materials to become viable alternatives. One of the most promising low-CO₂ alternatives is alkali-activated cements (AACs), which use large amounts of either natural or artificial aluminosilicate materials (e.g., coal fly ash, metakaolin clay, blast-furnace slag).

Microbial-induced concrete corrosion (MICC), a major global infrastructure challenge, stems from the microbial production of sulfuric acid (H₂SO₄) ubiquitous to concrete sewers. H₂SO₄ is produced at the concrete interface by reduction of hydrogen sulfide (H₂S), which originates from the decomposition of solids within sewer sludge by sulfur oxidizing bacteria. H₂SO₄ biogenic production leads to the formation of calcium sulfate phases (e.g., CaSO₄, Ca₆Al₂(SO₄)₃(OH)₁₂.26H₂O) via reaction of calcium components (e.g., Ca(OH)₂). As a result, the service life of this underground infrastructure is reduced and compromises the pipe structure due to the non-load bearing quality and expansive volume of calcium sulfate phases. The severity of this infrastructure issue is critical, as in some cases, the conversion rate to calcium sulfate phases ranges from 3.7-7.7 mm per year—an alarming rate for infrastructure deterioration.

Recent developments in alternative cementitious materials have suggested the use of these materials to circumvent sustainability and durability issues associated with OPC concrete. The most promising of these alternative cementitious materials are: (1) high-alumina cements, (2) magnesium phosphate cements, (3) slag cements, (4) alkali-activated cements, and (5) biocements. In some cases, these alternative cementitious material systems have demonstrated increased durability (i.e., high-temperature resistance, low shrinkage, high acid resistance) due to their alternative cement chemistries (e.g., lower calcium content). In addition, these cements often generate lower CO₂ emissions during production—up to 50% CO₂ reductions when compared to OPC production. One of the most promising and tailorable cements in this cohort are AACs. AACs have gained interest in recent years due to their potential to counter both sustainability and durability concerns associated with OPC. However, their full-scale implementation is hampered by (1) durability-based gaps in knowledge, (2) high product variability, and (3) unreliable life cycle assessments.

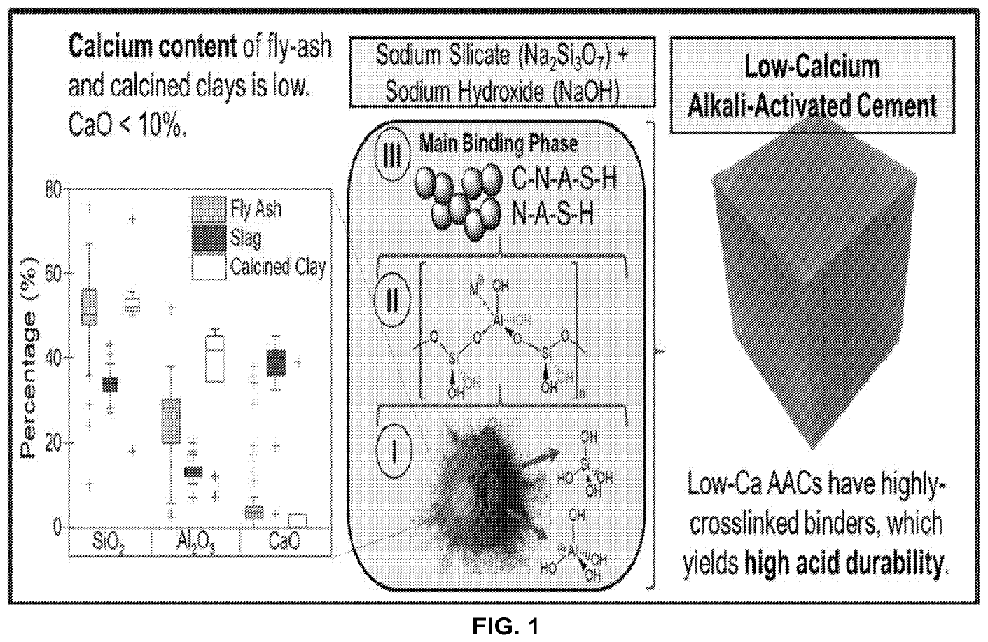

The theoretical basis of alkali-activated materials was developed by Ukrainian scientist V. Glukhovsky in 1959. In general, AACs utilize aluminosilicate precursors (e.g., fly ash, calcined clays, metakaolin, slag) to produce a variety of binders via the use of alkali activating solutions. Early work by V. Glukhovsky emphasized the compositional difference between OPC and rock-forming minerals. In 1959, V. Glukhovsky pioneered the term “alkaline cements,” and in 1967, classified these binders into two main cement groups, depending on the composition of the starting materials: (1) alkaline binding systems (Na₂O—Al₂O₃—SiO₂—H₂O or N-A-S-H) and (2) “alkali—alkaline—earth” binding systems (Na₂O—CaO—Al₂O₃—SiO₂—H₂O or C-N-A-S-H). The former, now termed low- calcium AACs, are produced from aluminosilicates with less than 10% CaO, such as calcined clays or fly ash, as illustrated in FIG. 1.

These binder phases are formed by (I) congruent dissolution of a fly-precursor and (II) polymerization of the SiO₄ and AlO₄ species where M+ is a metal cation (e.g., Na+1). These materials are known for their high acid durability.

Prior to the development of low-calcium AACs, the acid resistance of slag-based AACs was investigated by V. Glukhovsky as early as 1978. Acid resistance is defined as the degree of binder breakdown (dealumination) caused by protons, which results in changes to material properties, such as compressive strength, porosity, and mass. Subsequently, B. Tailing and P. Krivenko discussed the applications of these activated materials in the former Soviet Union area, especially in the Ukraine. In this area, pilot production of slag alkali cements started in 1958-1964. Their implementation when exposed to severe conditions demonstrated satisfactory performance after 8-12 years of service. As a result, these materials were found to be very effective in special construction engineering, especially those involving acid resistance. Oftentimes, these slag-based AACs were supplemented with dehydrated magnesium silicate or zeolite-containing rocks and were used as an underlayer for the floors in sulfuric acid pumping station warehouses and slabs used in the facing of drainage channels in the areas where chemical water is purified.

These initial investigations, which utilized loss of compressive strength, mass loss, and corrosion depth to characterize acid degradation, yielded important insights into the factors that affect the degradation of AAC materials. In general, ASTM C267 and modifications thereof have been utilized to understand the chemical resistance of mortars and concretes. In general, both standardized and general acid degradation testing rely on mass loss, compressive strength, and visual appearance of specimens to evaluate the effects of the chemical aggressor. In 2012, corroded depth was demonstrated to be a more sensitive measure of the acid degradation of cementitious materials. Despite these advances, compressive strength (and, in some cases, porosity) are widely utilized to understand acid degradation as it indirectly measures the breakdown (dealumination) of the cementitious binder. Regardless of material response utilized, studies have demonstrated that the acid degradation of AACs is dependent on a number of physical and chemical factors, including: acid type, acid concentration, surface-area-to-volume ratio, exposure conditions, pore size distribution, acid neutralizing capacity, binder chemical composition, pore solution chemistry, binder structure, and solid phases. Examples in accordance with the disclosure utilized direct measurements of dealumination using a modified ASTM C1308 methodology coupled with nano- and micro-resolution spectroscopic tools (e.g., FTIR, SEM-VMS) as well as an analysis of relevant material properties (compressive strength and porosity) to assess the acid degradation of low-calcium AACs.

Later, multiple studies on low-calcium AACs have demonstrated superior acid resistance when compared to both high-calcium AAC and OPC materials. In 1988, J. Davidovits and M. Davidovics proposed that geopolymers (i.e., calcium-free AACs) demonstrate good acid resistance in concentrated sulfuric acid, but a poor performance in concentrated hydrochloric acid. Further development occurred in 1989 and later in 2000, when the use of geopolymer materials for mine tailing waste encapsulation due to their high acid resistance was proposed. Later, in 2004, a U.S. patent was filed on the “Composition of Materials for Production of Acid Resistant Cement and Concrete and Method Thereof.” In the same year, one of the first studies on the acid resistance of low-calcium AACs was published by T. Bakharev. These low-calcium AACs were categorized as highly acid resistant due to their demonstrated low weight loss after exposure to 3% sulfuric acid and low compressive strength loss of about 30%.

Current research on low-calcium AACs indicates that the acid resistance of these materials can be further improved by: (1) increasing the Na₂O₃ content; (2) partial crystallization of non-reacted fly ash particles via calcination; (3) formation of mineral phases to induce material densification. Increasing the Na₂O₃ content of fly ash-based AAC formulations to 8% by weight of mixture has been shown to increase the residual compressive strength of the material when exposed to sulfuric or nitric acid for 24 weeks. Acid resistance is dependent on the mineralogical composition changes of the material as partial crystallization of non-reacted fly ash particles via calcination decreases acid dissolution of the material. It is typical for low-calcium AAC mortars and concretes to exhibit low mass loss and degradation depth despite having the lowest strength class and highest porosity. This observation can be explained by degradation rates, which are controlled by kinetics of binder degradation rather than mass transport (diffusion). Furthermore, an increase in strength during acid exposure is likely related to a densification of the exposed surface due to the formation of mineral phases, such as anorthite.

The kinetics of acid degradation in low-calcium AACs are mainly governed by rate of dissolution-precipitation chemical reactions, which depend on concentration variations brought about by diffusion. The latter being a rapid process due the high porosities of low-calcium AACs. To further illustrate this concept, consider the acid degradation of calcium-based cementitious materials—an inverse process to the degradation of low-calcium AACs. In calcium-based materials, acid degradation kinetics are controlled by the diffusion of the acid (the slowest process) since the rate of chemical dissolution-precipitation reaction, especially in the presence of sulfuric acid, is the most rapid process. As a result, local equilibrium at the interface of the reaction can be assumed and, as evidenced by recent experiments, the depth of the corroded layer is proportional to the square root of the immersion time. As a result, the corroded layer can be described by a dissolution (i.e., absence of ion of interest) or precipitation (i.e., presence of ion of interest) front. In the case of low-calcium AACs, the acid degradation reaction is chemically controlled and is described by a progressive spatial gradient of the solid phases participating in dissolution and precipitation reactions. These changes can be observed easily via the implementation of surface chemistry characterization tools, such as Wavelength Dispersive Spectroscopy (WDS).

The dissolution-precipitation chemical reactions occurring in low-calcium AACs during acid degradation have been previously discussed by Joseph Davidovits. In his book, Geopolymer: Chemistry and Applications, J. Davidovits attempted to describe the mechanisms of acid degradation in geopolymers by relating it to that of the acid dissolution of feldspars aluminosilicate minerals. J. Davidovits proposed equation 1 and equation 2 (shown below) to describe the mechanism of acid degradation for “well condensed” geopolymer phases (i.e., poly(sialate), poly(sialate-siloxo), and poly(sialate-disiloxo)). During the first step of degradation, Si—O—Si bonds would be primarily susceptible against hydronium attack, depicted as H⁺ in equation 1, due to lack of metallic cation (e.g., Na, K, Ca) protection of the bond. Recent research on geopolymers has shown that the degradation of these materials is primarily affected by the silica modulus (SiO₂:Na₂O, Ms) of the activating solution, which affect the silicon content (Si:Al) of the material's microstructure. Subsequently, scission of the Si—O—Si bond yields the formation of silanol units and silicon-anion compounds, described as Si—OH and Si—X in equation 2. J. Davidovits proceeds to claim that the “destruction of the geopolymer backbone is limited to the effective amount of anion (X−) present in the solution . . . the rate limiting parameter.”

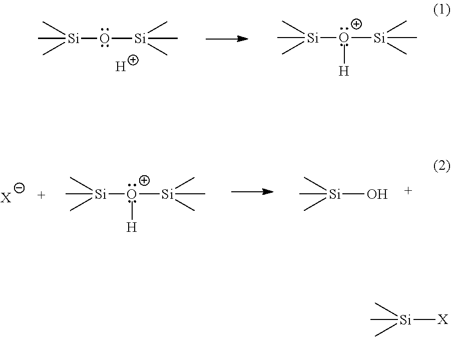

In the proposed mechanism, J. Davidovits claims that hydronium ions firstly attack the Si—O—Si bonds since Si—O—Al bonds are protected by cations. However, no evidence has been provided for this assertion. As a consequence, J. Davidovits suggested that the dissolution of geopolymers should be similar to the dissolution of feldspars. Careful analysis of the sources provided by J. Davidovits on the dissolution of feldspars reveals that the first step in alkali-feldspars dissolution is an intercationic exchange followed by congruent dissolution of the mineral. Furthermore, the focus of the hydronium attack is controlled by localized accumulation of negative charges, which are imparted to the structure of aluminosilicates by aluminum tetrahedrals (i.e., not present in Si—O—Si bonds). Thus, negating J. Davidovits previous claims. Moreover, he also claims Si—X, where X is the conjugate base of the acid, to be the rate limiting parameter. This is not in agreement with extensive studies on geochemical processes for feldspars as the rate-limiting mechanism is the irreversible process of acid degradation, as previously explained, which creates the H₃O.AlSi₃O₇.H₃O species. These species, depending on pH, lower the chemical affinity of the reaction. Thus, the extent of degradation depends on the acid concentration and exposure period.

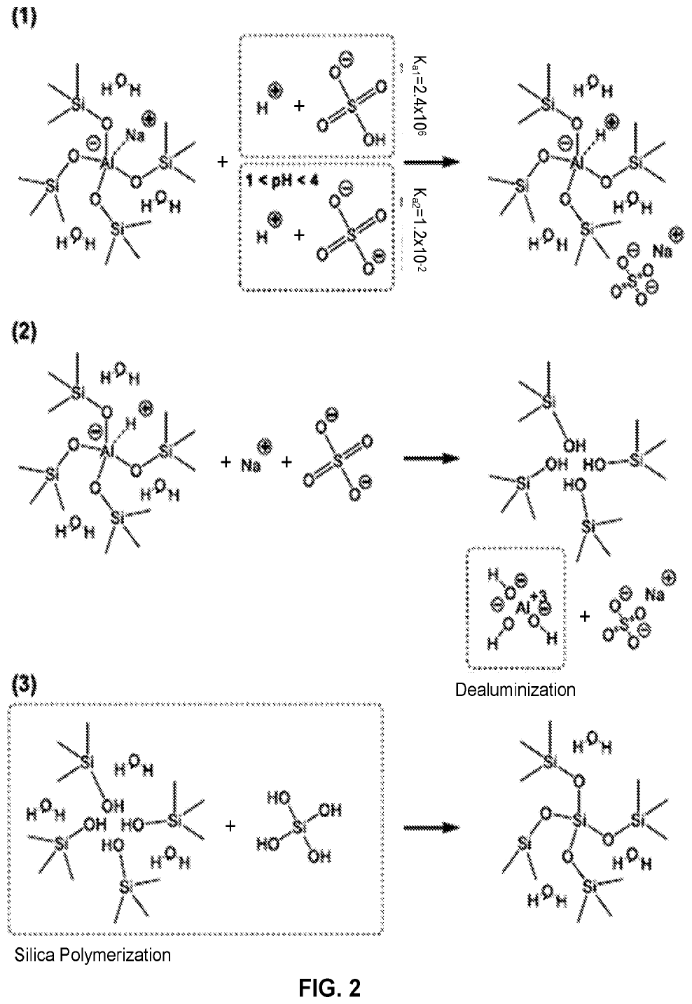

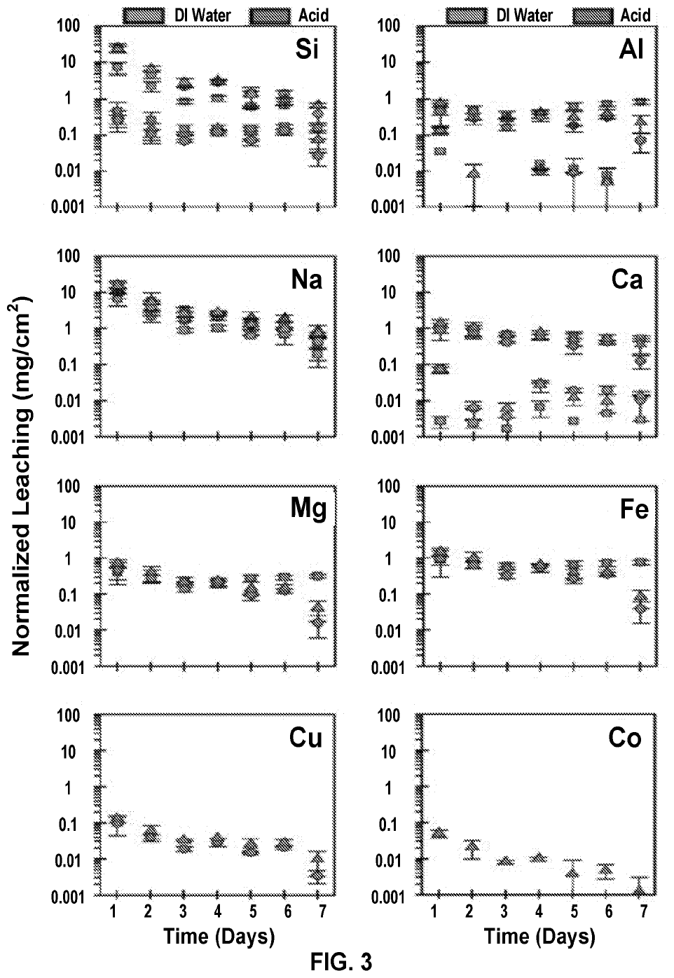

The currently understood acid degradation mechanism of low-calcium AACs when exposed to H₂SO₄ (diprotic acid) is presented in FIG. 2. Acid degradation mechanism of a low-calcium AAC in the presence of sulfuric (diprotic) acid. Note that complete dissociation of sulfuric acid's second proton will occur at pH values of 4.0. This mechanism initiates via exchange between interlayered alkali cations (Na⁺, K⁺, Ca⁺², Mg⁺²) and hydronium ions (H₃O⁺). This exchange leads to destabilization of the aluminosilicate framework, resulting in electrophilic attack of Si—O—Al bonds and the formation of Si—OH and Al—OH groups. The release of Al—OH results in dealumination of the aluminosilicate binder and, hence, is taken as the main proxy for the acid degradation of the cementitious binder. Further initial cation exchange leads to decalcification of the cementitious binder and formation of soluble salts, namely calcium acetate when exposed to acetic acid or gypsum when exposed to sulfuric acid. In addition to soluble products, fissure cracks are formed, likely due to destabilization of the aluminosilicate framework (formation of silica gels) and formation of expansive calcium sulphate phases, which results in a loss of mechanical integrity. Concomitant increased acid resistance has been attributed to the formation of decalcified and modified aluminosilicate gel upon exposure to acid. Released monomeric silica species undergo polymerization and subsequent gelation to form an amorphous silica gel with beneficial properties, which is thought to limit the rate of acid degradation reaction.

As noted above, examples of the disclosure relate to acid-resistant composite materials. Exemplary acid-resistant composite materials can include greater than 0% to about 75%, or about 40% to about 60% SiO₂; greater than 0% to about 75%, or about 30% to about 50% Al₂O₃; no added or about 1% to about 25%, or about 1% to about 20% CaO; greater than 0% to about 25%, or about 0.1% to about 10%, or about 1% to about 10% one or more monovalent, divalent, or polyvalent cationic metals; and greater than 0% to about 25%, or about 0.1% to about 10%, or about 1% to about 10% one or more other inorganic materials. The one or more monovalent, divalent, or polyvalent cationic metals can comprise one or more transition metals. In accordance with examples of the disclosure, the one or more monovalent, divalent, or polyvalent cationic metals comprise one or more group 2 or group 8-11 metals. By way of particular examples, the one or more monovalent, divalent, or polyvalent cationic metals can comprise one or more metals selected from the group consisting of titanium, lithium, chromium, calcium, copper, cobalt, iron, and magnesium. In some cases, the acid-resistant composite material comprises a plurality of the metals.

In accordance with further examples of the disclosure, a ratio of silicon to aluminum in the acid-resistant composite material is about 0.75 to about 3.0, or about 1.0 to about 2.0. Additionally or alternatively, a ratio of sodium to aluminum in the acid-resistant composite material is about 0.8, or about 0.9 to about 1.4, or about 0.8 to about 1.2.

In accordance with further examples, a method of forming an acid-resistant composite material includes dissolving one or more alkaline metal salts in a solution, and adding the solution to one or more aluminosilicate precursors and optionally other minerals to form a mixture. The one or more aluminosilicate precursors can include a synthetic aluminosilicate precursor, metakaolin, fly ash, slag, pumice, basalt, glass, and/or other natural pozzolan. Exemplary methods can further include a step of filtering the mixture, a step of drying the mixture to form a dried material, a step of grinding the dried material, and/or adding an alkali additive to one or more of the mixture and the dried material. The step of adding an alkali additive to one or more of the mixture and the dried material can include adding a solid and/or a liquid. In accordance with further examples of the disclosure, the alkali additive comprises one of more of sodium silicate, sodium hydroxide, potassium hydroxide, or sodium carbonate.

### Specific Examples

The examples provided below, including the additional examples, are merely exemplary and are not meant to limit the scope of the disclosure or invention described herein. Further, any values (e.g., temperature, times, percentages, molecular weights, amount, and the like) set forth below can be the ranges set forth elsewhere herein and/or±10 percent,±5 percent, or±2 percent of the stated values, unless noted otherwise.

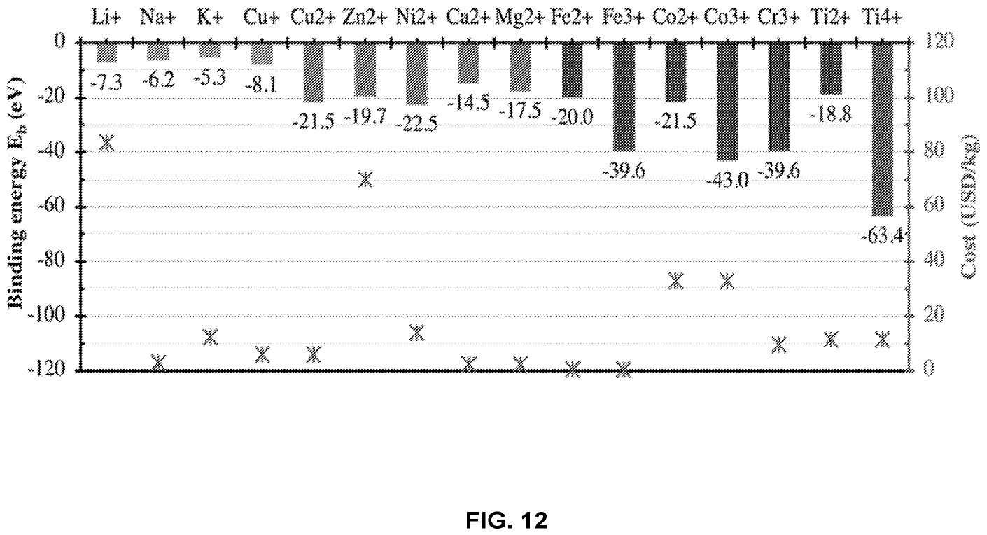

Motivated by previous work related to antimicrobial metals and acid-resistant AACs, the inventors investigated the effect of incorporating micro-doses of heavy metals, namely copper (Cu) and cobalt (Co), iron (Fe), magnesium (Mg), titanium (Ti), lithium (Li), chromium (Cr), and calcium (Ca) on the acid resistance of AACs. FIG. 12 illustrates exemplary metals suitable for use with examples of the disclosure.

In the examples discussed below, three samples of binary metakaolin- and metal-doped basic oxygen furnace (BOF) slag-based AACs were prepared and exposed to sulfuric acid. Acid exposure was correlated with changes in mineralogy, chemical composition, and physical properties, including bulk permeable porosity and acid corrosion depth. Microstructural evolution and elemental mobility were also investigated via X-ray diffraction and electron microprobe analysis (EMPA), respectively, after semi-dynamic leaching in sulfuric acid solutions.

### Materials

Basic oxygen furnace slag (BOF-S), obtained from the Indiana Harbor East Steel Mill complex (Indiana, USA), and metakaolin (MK) (MetaMax), supplied by BASF Chemical Corporation (Georgia, USA), were used as aluminosilicate precursors for alkali-activation. Cu(NO₃)₂ (99% purity, Acros Organics) and Co(NO₃)₂ (99% purity, Acros Organics) were both utilized to adsorb heavy metals onto the BOF-S precursor.

### Experimental Methods

### Copper (Cu) and Cobalt (Co) Adsorption

Batch heavy metal (i.e., Cu, Co) adsorption onto BOF-S was performed as follows. First, 10 g of Cu(NO₃)₂ were added to one liter of deionized water until completely dissolved. Next, 50 g of slag (Sieve No. 20: 841 μm) were added to the solution and mixed overnight at 150 rpm and room temperature. After this process, the Cu-laden slag (Cu—S) was separated from the solution using qualitative filter paper (No. 1, Whatman), rinsed with water to remove any unattached particles, and oven dried at 40° C. A similar procedure was performed to create the same material, which was laden with Cu and Co (Cu/Co—S); however, in addition to Cu(NO₃)₂, 10 g/L of Co(NO₃)₂ were dissolved in the initial solution prior to slag addition. Next, the BOF-S was ground in mill capsules with clean, packed yttrium-stabilized zirconium grinding beads (American Elements) using a McCrone micronizing mill. A No. 100 sieve was used to ensure a sub-149 μm particle size.

Table 1 shows the chemical composition of all AAC precursors (MK, BOF-S, Cu—S, and Cu/Co—S) determined by ICP-OES, on a calibrated ARL 3410+, using modifications to a widely accepted technique developed by Farrell et al. Five mL of a 7:3 mixture of hydrochloric acid and hydrofluoric acid were combined with 2 mL of nitric acid and placed in digestion tubes that were maintained at 95° C. in a digestion block (HotBlock, Environmental Express) for approximately two hours. Samples were then cooled and brought to 50 mL with a 1.5% boric acid solution (by mass). The samples were then reheated to 95° C. for 15 minutes and cooled for analysis. The samples were diluted 10× with deionized water and analyzed with an ICP-OES, as described above. An analytical blank, along with three standards that were made by accurately diluting certified standards, was used for calibration. A basaltic internal standard (Valmont Dike, Colorado, USA) of known chemical composition was digested and analyzed to ensure the accuracy of the chemical composition results shown in Table 1. Precursors were supplemented using a reagent-grade sodium silicate (NaSi) solution supplied by Sigma-Aldrich. The chemical composition of the NaSi solution was determined to have a SiO₂:Na₂O molar ratio of 2.5 (SiO₂=27 wt. %, Na₂O=11 wt. %, H₂O=62 wt. %), as obtained via ICP-OES as previously described.

TABLE 1
Chemical composition of MK, BOF—S, CU—S, and Cu/Co—S in weight percent.

| Precursor | SiO₂ | Al₂O₃ | CaO | SO₄ | Fe₂O₃ | K₂O | Na₂O | MgO | MnO | Cu | Co | P₂O₅ |
|---|---|---|---|---|---|---|---|---|---|---|---|---|
| MK | 52.1 | 41.3 | 0.07 | 0.3 | 0.36 | 0.11 | 0.33 | — | — | — | — | 0.08 |
| BOF—S | 14.7 | 6.6 | 31.7 | 0.4 | 25.8 | <0.05 | 0.1 | 10.8 | 2.5 | — | — | 0.7 |
| Cu—S | 14.4 | 7.4 | 29.1 | 0.3 | 24.2 | <0.05 | 0.1 | 10.7 | 2.6 | 2.4 | — | 0.1 |
| Cu/Co—S | 13.6 | 6.7 | 28.9 | 0.2 | 26.3 | <0.05 | 0.1 | 6.5 | 2.4 | 1.5 | 1.3 | 0.7 |

### AAC Sample Preparation

AACs were prepared by mixing 66% MK and 33% BOF-S by weight with NaSi solution according to the prescribed mix design parameters shown in Table 2. All materials were mixed at room temperature using a Waring PDM112 mixer. To ensure no material residual remained on the sides of the vessel, the mixing procedure was repeated twice: one minute of manual mixing, followed by one minute of mechanical mixing. Samples were then cured inside hermetically sealed plastic containers for 72±1 hours at 100% relative humidity and 22° C. The constant humidity chamber was prepared according to ASTM E104 by placing a supersaturated salt solution of sodium phosphate (Sigma-Aldrich) inside the plastic containers. After this period, both samples were cured inside a Quincy forced air laboratory oven set to 20° C. for 25.5±1.5 hours.

Paste samples were cast in both small cylinder molds (diameter 2.4 cm, height 1.5 cm) used for semi-dynamic leaching experiments (see below) and longer cylinder molds (diameter 1.4 cm, height 4 cm) that were used to determine acid corrosion depth (see below).

TABLE 2
Sample classification and mixture proportions for MK-BOF—S AACs. Important parameters
are reported in molar atomic ratios (Si:Al, Na:Al) and molecular ratios (H₂O:Al₂O₃).

| | Solids | | Alkali-Activating Solution | Important Parameters | | |
|---|---|---|---|---|---|---|
| Mixtures | MK (g) | Slag (g) | Sodium Silicate (ml) | Si:Al | Na:Al | H₂O:Al₂O₃ |
| Control | 80 | 40 | 122 | 2.0 | 0.8 | 15 |
| Control + Cu | 80 | 40 | 122 | 2.0 | 0.8 | 15 |
| Control + Cu/Co | 80 | 40 | 122 | 2.0 | 0.8 | 15 |

### Semi-Dynamic Leaching

Cast samples (diameter 2.4 cm, height 1.5 cm) were placed in polypropylene plastic containers with either sulfuric acid solution (1% v/v) or deionized water at a volume-to-surface area ratio of 10, as described by ASTM C1308. In addition, samples were suspended by triangular plastic stands to allow full surface exposure to the acidic medium. Exposure media was replaced daily for seven consecutive days for each of the three replicates. Samples of leachate media were taken before each replacement. Prior to characterization, samples were dehydrated by solvent exchange with anhydrous ethanol (200 proof, 0% H₂O, Decon Labs) and dried at 40° C. overnight in a Quincy forced air laboratory oven. Leachate media samples were analyzed with ICP-OES and ICP-MS.

### Desorption Potential and Acid Neutralization Capacity

Cured AAC specimens were crushed using a mortar and pestle to pass a No. 100 mesh sieve (<149 μm). Solutions containing deionized water and H₂SO₄ (97% w/w) were prepared to establish a concentration gradient of H₃O⁺ (expressed as equivalents of acid per kg of AAC). The powdered specimens were added to the solutions at a liquid-to-solid ratio of 20. Portions of powdered specimens for all three AAC samples were chemically characterized via ICP-OES to determine an initial concentration of elements. Batches were mixed overnight at 150 rpm and room temperature. Final pH of the solutions was measured and batches were then centrifuged at 5000 rpm for 10 minutes. The supernatant was analyzed for soluble cations using ICP-OES and the solid was oven dried at 40° C. and analyzed for their mineral profiles on a Siemens D500 X-ray diffractometer. The initial chemical compositions of the powders were compared with the chemical compositions of the supernatant after batch reactions to calculate a leached percentage of each element (Si, Al, Na, Ca, Mg, Fe, Cu and Co) with respect to the total initial mass of each.

### X-Ray Diffraction (XRD)

To determine mineralogy, AAC samples were first crushed into a powder with a mortar and pestle. The former method was modified to employ corundum as an internal standard instead of zincite. A Siemens D500 X-ray diffractometer was used to acquire energy dispersion patterns for all samples. Samples were analyzed from 5 to 65 degrees 2θ using Cu Kα X-ray radiation, with a step size of 0.02 degrees and a dwell time of 2 seconds per step. Mineralogy was identified using Jade software (MDI, Version 9) and the International Centre for Diffraction Data (ICDD) 2003 database. Corundum was used to normalize peak heights between samples and align diffraction patterns.

### Bulk Permeable Porosity

Permeable porosities were measured using a vacuum saturation method, which was selected because it has improved efficiency compared to conventional laboratory methods for estimating permeable porosity. The method was modified by using anhydrous ethanol in lieu of water to prevent any hydration reactions from occurring during the analysis. Sample volumes were observed by measuring sample dimensions with calibrated micro-calipers and vacuum-saturated with ethanol for 24 hours. The saturated-surface-dry (SSD) weight was recorded using a Mettler Toledo PL 1502E scale after ethanol-vacuum immersion. Samples were then dried at 40° C. for 24 hours and their oven-dry (OD) weights were recorded. Permeable porosity was calculated as the difference in SSD mass and OD mass normalized by the density of ethanol (0.803 g/cm³), all divided by total sample volume.

### Corrosion Depth

Cast cylindrical samples (diameter 1.4 cm, height 4 cm) were wrapped with commercial electrical tape twice at both the curved and bottom surfaces of the cylinder, leaving only one circular face exposed. Samples were submerged in sulfuric acid solution (1% v/v) at a volume-to-surface ratio of 30 to determine corrosion depth in one dimension. After acid exposure, samples were dehydrated by immersion in anhydrous ethanol (200 proof, Decon Labs) and dried at 40° C. overnight in a Quincy forced air laboratory oven. The corrosion layer was qualitatively identified by obvious color change and corrosion depths were quantitatively measured using calipers as previously described. The weak product layer was evaluated by measuring the total height dimension of the sample before and after brushing with a commercial copper wire brush until no additional residue detached from the material.

### Electron Micro-Probe Analysis (EMPA)

The mobility and fate of elements of interest before and after exposure to sulfuric acid were analyzed by compiling X-ray element maps of Si Kα, Al Kα, S Kα, Ca Kα, Na Kα, Fe Kα, Mg Kα, Co Kα, and Cu Kα, which were obtained using a JEOL-8230 electron microprobe. In some cases, two maps for Cu Kα were aggregated to enhance precision. An acceleration voltage of 15 keV and beam current of 100 nA was used for all maps. The electron beam was defocused to 5-6 μm to match the pixel size, and a dwell time of 20 msec was used. Element maps were treated with Calclmage (ProbeSoftware, Inc.) to remove the background using the mean atomic number background correction, and a matrix correction was additionally performed as desired for quantitative work. Raw data, expressed as net counts, are semi-quantitative, since each pixel likely represents a mixture of two or more phases. Considering these material limitations, atomic percentages were quantified to discern the central tendencies of bulk Si:Al ratios using statistical analysis. EMPA data were analyzed for statistical significance by utilizing Minitab 18.1 statistical analysis software.

### Experimental Results

### Dissolution Behavior of AACs

### Semi-Dynamic Time-Dependent Leaching

The time-dependent leaching behaviors of all samples exposed to deionized water are shown in FIG. 3. Elemental leaching decreases with exposure time in all samples and for all elements. Under this scenario, the elements which dominated leaching on a molar basis were silicon (Si) and sodium (Na), while concentrations of other elements were either not present or were below the method detection limit. For example, the Si leaching in the Control sample, on the order of 7.4 mg/cm² in the first day, decreased 68% by the second day. No other evidence of elemental leaching was observed.

Formulations containing copper (Cu) and cobalt (Co) exhibited higher normalized leaching of both Si and Na in deionized water (FIG. 3). The addition of Cu and Co increased the leaching of Si by a factor of approximately 3.4 when compared to the Control. While Na ions exhibit similar leaching behavior as Si ions in all samples, the addition of Cu and Co effectively doubled the Na leaching output in comparison to the Control.

As shown in FIG. 3, acid exposure induces elemental mobility in the AAC matrix, but samples containing Cu and both Cu and Co leach lower amounts of iron (Fe), magnesium (Mg), aluminum (Al), and calcium (Ca) than the Control. While Na leaching does not differ between samples, leaching of Ca in the samples containing Cu is lower than the Control after the first day of acid exposure. Similarly, the leaching of the samples containing Cu is lower than that of the Control for Fe, Mg, Si, and Al ions after one day of exposure. The leaching profile from AAC samples containing both Cu and Co is also lower after the second day of acid exposure with respect to Fe, Mg, and Al ions.

### Desorption Potential and Acid Neutralization Capacity

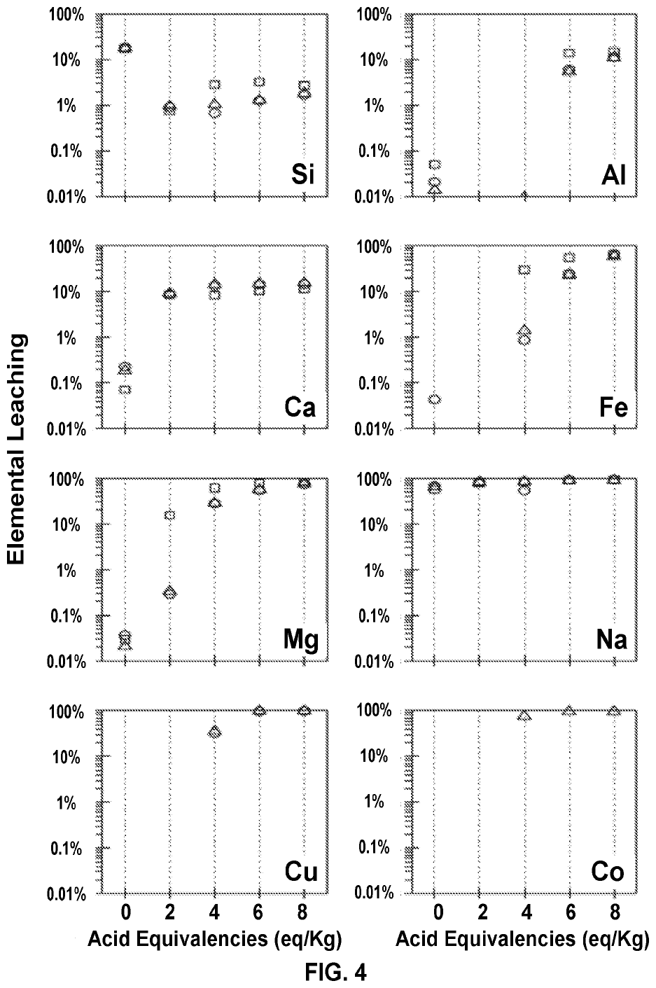

From leaching profiles shown in FIG. 4, it is evident that all formulations liberated increasing quantities of chemical constituents in response to acid exposure (with the exception of Si). The results suggest that cations can be grouped based on the difference between the percentage leached at 8 eq/kg of acid exposure and the percentage leached at the baseline condition (0 eq/kg of acid exposure): (1) mildly affected (<20% difference) by acid addition (Ca, Si, Al) and (2) strongly affected (>20% difference) by acid addition (Mg, Na, Fe, Cu, Co). Leached Ca increases from nondetectable to a stable magnitude of approximately 16% when acid exposure was above 4 eq/kg. Si and Na were the only cations leached in the absence of acid. However, net Si leaching declined in response to increasing acid exposures, while Na plateaued at 90% at or above 6 eq/kg acid exposure. Al was detected at and above 6 eq/kg acid exposure, with a maximum leaching of 15% at 8 eq/kg acid exposure. Additionally, Mg and Fe gradually increased presence in response to increasing acid exposures to their respective maxima of 84% and 68% when acid exposure conditions were 8 eq/kg. Cu and Co gradually increase their presence in the leachates as well; these metals were not detectable in the absence of acid but equilibrated at approximately 98% in the leachate at and above 6 eq/kg acid exposure.

The pH at the end of these experiments indicated the neutralization capacity of the different AAC formulations. As seen in Table 3, no significant differences are observed between formulations. pH values decreased in response to acid addition to pH 2 in an 8 eq/kg acid solution in all sample formulations.

TABLE 3
Batch solution pH after 24 hours of acid
exposure at 1:20 solid-to-liquid ratio.

| | 0 eq/kg | 2 eq/kg | 4 eq/kg | 6 eq/kg | 8 eq/kg |
|---|---|---|---|---|---|
| Control | 11.44 | 9.64 | 5.32 | 3.34 | 2.17 |
| Control + Cu | 11.39 | 9.65 | 5.23 | 3.33 | 2.23 |
| Control + Cu/Co | 11.39 | 9.64 | 5.02 | 3.21 | 2.08 |

### Mineralogy

### Mineralogical Response of Bulk AACs Upon Acid Exposure

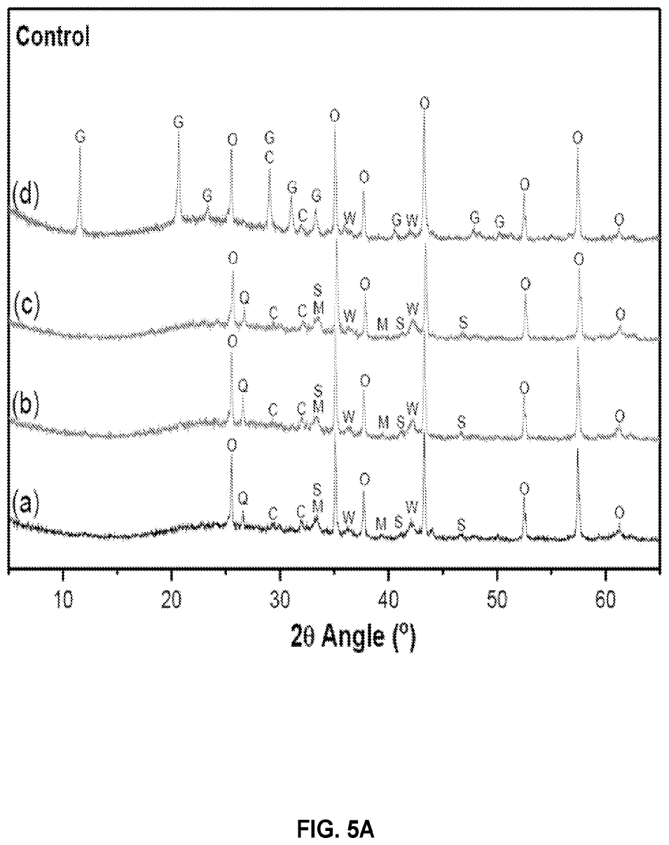

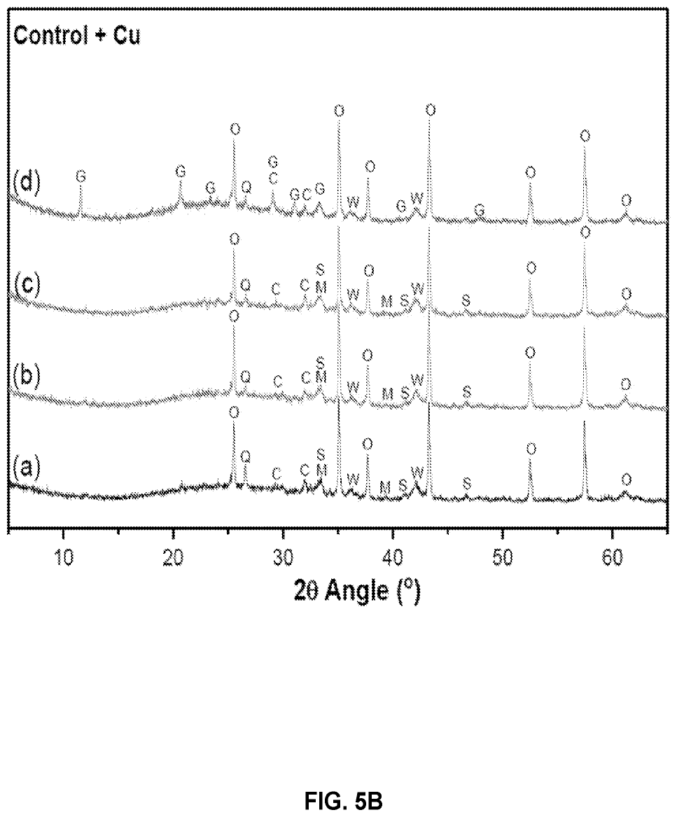

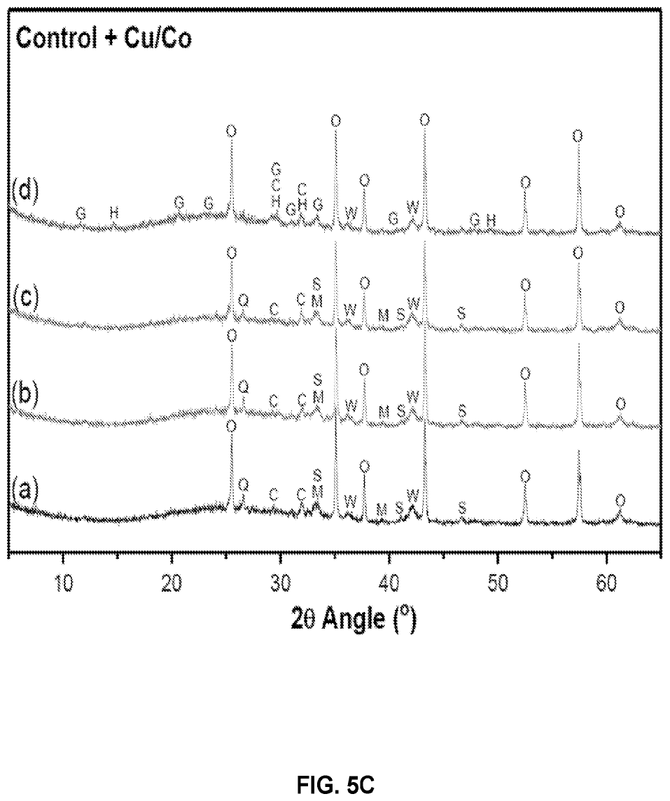

FIG. 5 shows mineralogical profiles of the cast (bulk) AAC samples after exposure to different environmental conditions, including sulfuric acid. Salient minerals identified with XRD are listed in Table 4 with the corresponding unit geometry, volume, and density, as determined by each reference standard. Symbols correspond to the peaks identified in FIG. 5.

Alkali activation of the Control formulation resulted in a cementitious material with traces of the original mineral composition. Minor mineralogical differences between the raw BOF-S, Cu—S, and Cu/Co—S precursors were initially detected (data not shown). After alkali-activation, traces of quartz, srebrodolskite, merwinite, and wüstite present in the original BOF-S precursor were detected. Data indicate complete reaction of belite, which resulted in the formation of calcium silicate hydrate (C—S—H) phases in all cement samples.

No significant mineral changes were observed between dehydrated AAC samples (FIG. 5(a)), samples at ambient conditions (FIG. 5(b)), or samples exposed to deionized water (FIG. 5(c)). Following exposure to sulfuric acid, however, samples containing Co and Cu had notably lower gypsum content compared to the Control (FIG. 5(d)). However, the acid-exposed Control containing Cu and or Co showed traces of calcium sulfate hydrate (Table 4), a similar mineral, with a larger unit cell volume and lower density.

TABLE 4
Summary of observed minerals as determined by XRD. Mineral shapes, unit volumes, and
densities were obtained using the Jade5 mineral database as a reference standard.

| | | | | Unit Cell | | |
|---|---|---|---|---|---|---|
| | | | | Volume | Density | |
| Mineral Name | Stoichiometry | Symbol | Unit Geometry | (Å3) | (g/cm³) | PDF # |
| Srebrodolskite | Ca₂Fe₂O₅ | S | Orthorhombic | 448 | 4.04 | 00-038-0408 |
| W\ddot{ }stite | Fe_{0.9536}O | W | Cubic | 78.5 | 5.613 | 01-074-1880 |
| Merwinite | Ca₃Mg(SiO₄)₂ | M | Monoclinic | 659.3 | 3.15 | 00-035-0591 |
| Quartz | SiO₂ | Q | Hexagonal | 113 | 2.66 | 00-046-1045 |
| Calcium Silicate | Ca_{1.55}SiO_{3.x}(H₂O) | C | — | — | — | 00-033-0306 |
| Hydrate | | | | | | |
| Calcium Sulfate | CaSO₄•0.62(H₂O) | H | Hexagonal | 2,119.90 | 0.115 | 00-041-0225 |
| Hydrate | | | | | | |
| Gypsum | CaSO₄•2(H₂O) | G | Monoclinic | 495.4 | 2.32 | 00-033-0311 |
| Corundum | Al₂O₃ | O | — | 253.54 | 3.98 | 00-010-0173 |

### Mineralogical Response of Powdered AACs Upon Acid Exposure

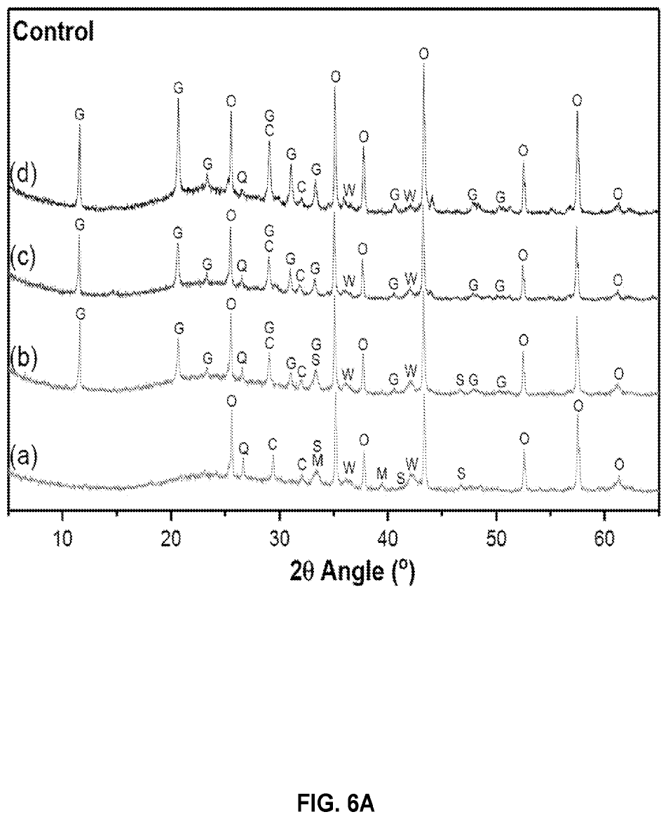

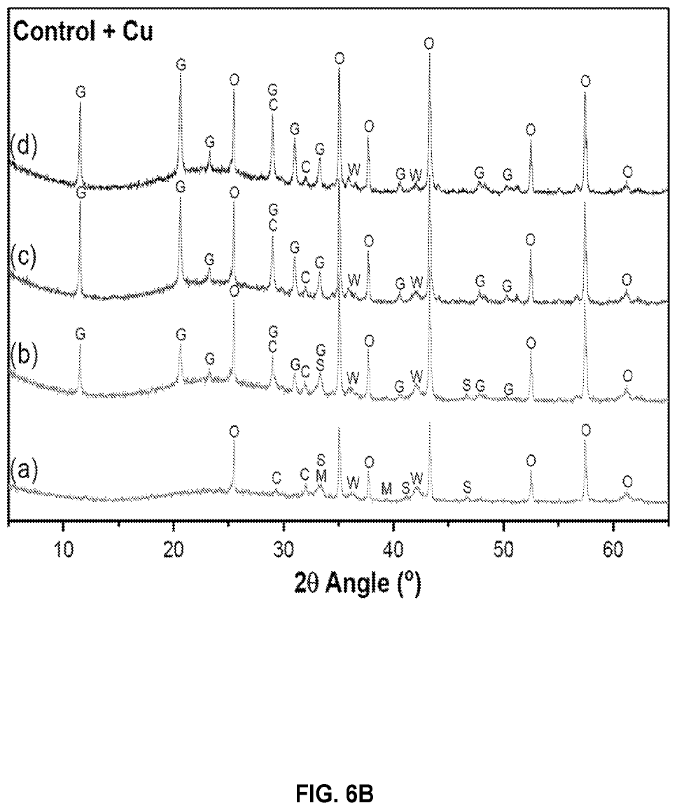

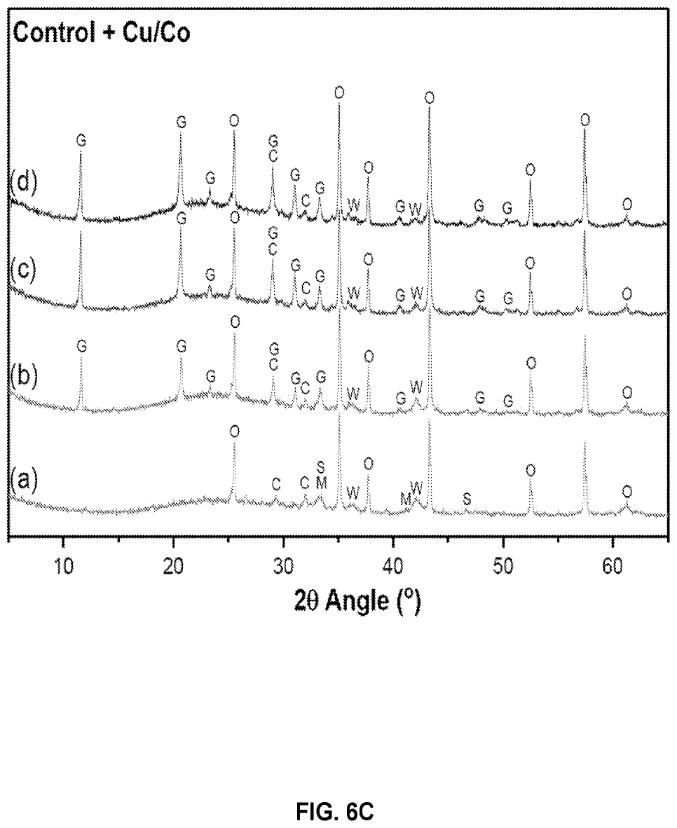

As judged by acid equivalents, acid strength affected the formation of gypsum and other minerals (FIG. 6) in powderized samples. As discussed, powdered samples were used in conjunction with cast (bulk) samples to explicitly study element liberation and mineral formation and identify changes in mineralogy in response to acid strength. AAC powders exposed to sulfuric acid formed gypsum when acid additions were greater than 4 eq/kg, with minimal changes in the diffraction intensity of gypsum noted in response to increased acid strength. Results of AAC powders exposed to deionized water (FIG. 6(a)) indicate the presence of both quartz and srebrodolskite, further substantiating the results obtained and shown in FIG. 5.

### Permeable Porosity

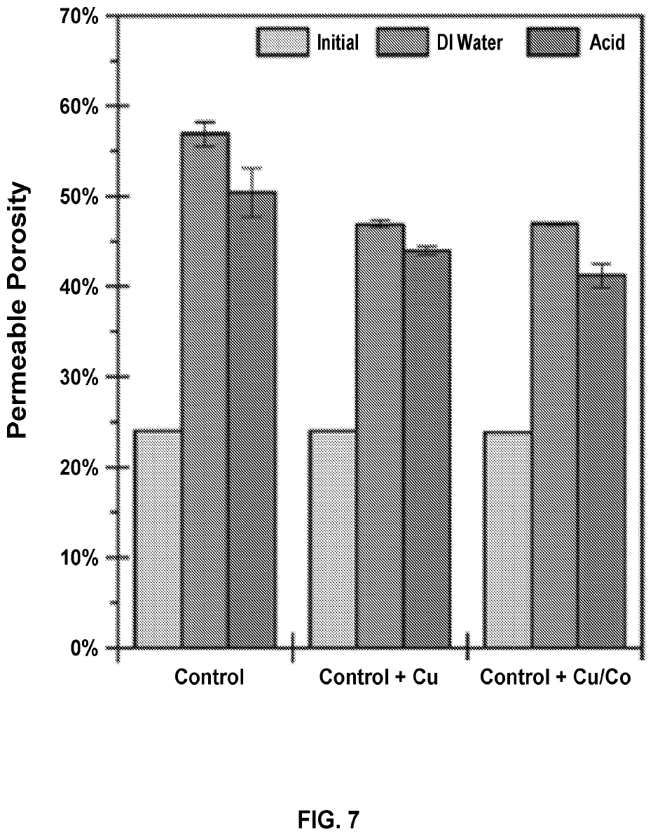

After exposure to deionized water and sulfuric acid, all AAC materials increased in permeable porosity (FIG. 7). The Control exhibited the highest permeable porosity of all sample formulations when exposed to either water or acid. When exposed to the same, samples including Cu and Co resulted in lower porosities when compared to the otherwise identical Control. Comparison between Control+Cu and Control+Cu/Co samples indicate no statistically significant difference in porosity upon exposure to water. However, when exposed to acid, the Control+Cu/Co sample exhibited the lowest porosity overall.

### Corrosion-Layer Depth

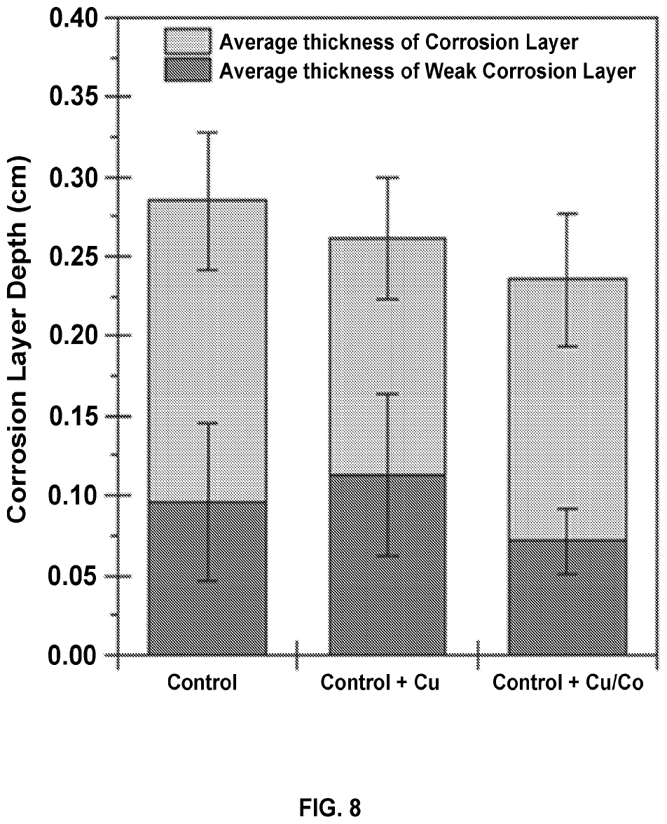

Addition of heavy metals in AACs resulted in a decrease of the corrosion-layer depth as shown in FIG. 8. Cu and Cu/Co, respectively, decreased the corrosion-layer depth by 8% and 17%., respectively More specifically, results demonstrate that addition of Cu/Co reduced the average thickness of the weak corrosion layer by approximately 26% compared to the Control samples without heavy metal addition.

### Elemental Maps of AACs Exposed to Acid

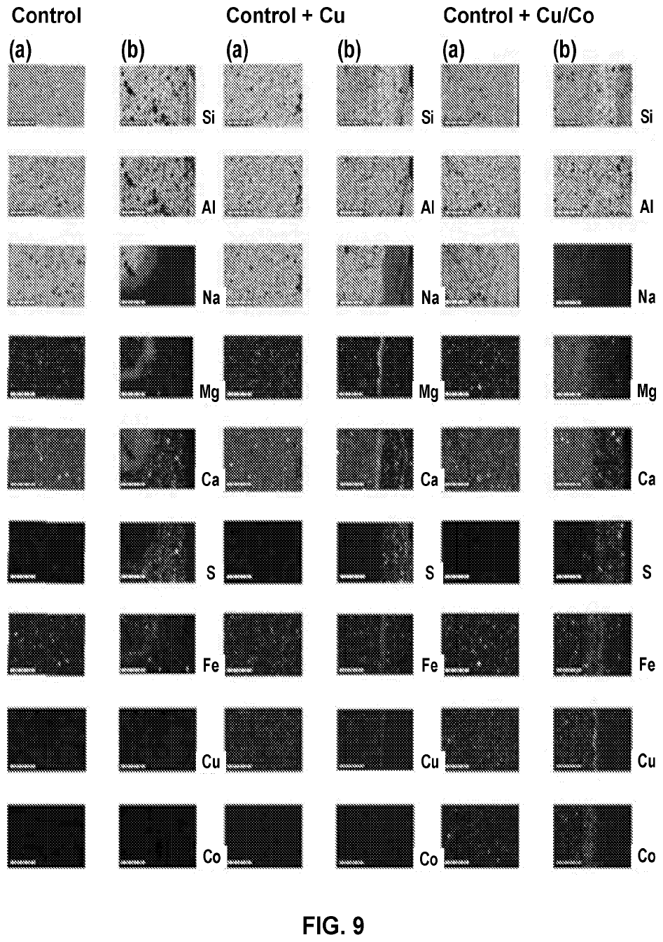

Elemental compositions of the AAC samples before and after seven days of sulfuric acid exposure are shown in FIG. 9. As shown in FIG. 9(a), all samples have an initially homogeneous distribution of elements within the AAC microstructure before acid exposure.

After acid exposure, some similarities remain between samples (FIG. 9(b)). Overlap between Ca, Fe, and Mg net intensity counts, for example, indicate the presence of unreacted mineral phases found in the BOF-slag precursor (see FIG. 9(a)). Net elemental intensity counts between the different samples indicate different solid phases that form in response to acid exposure (FIG. 9(b)). For example, after acid exposure, overlap between the net intensities of both Ca and sulfur (S) maps indicate precipitation of gypsum within cracks and pores of the AAC samples, corroborating evidence from the XRD patterns. In addition, the visually observable corrosion layer is depicted in each sample by the decalcification present in the Ca maps (FIG. 9(b)).

Despite these similarities, many notable differences between formulations are evident after acid exposure. For instance, while acid exposure induces transience of Si and Al in all samples, the extent of their mobility and ultimate fate differ among samples. Si-rich bands developed with more distinct uniformity in samples containing Cu and Co (FIG. 9(b)). Si in the Control sample is observed to form a heterogeneous distribution of Si-rich areas. Dealumination (ejection of Al from the AAC binder) was observed in all samples; however, as judged by elemental mapping, dealumination decreased in formulations containing Cu and Co. After acid exposure, cation mobility occurred past the border of what macroscopically corresponded to the corrosion layer (FIG. 9(b)). While Na was observed to leach out of all AAC formulations, Na redistributed past the visually observable corrosion layer in the Control and Control+Cu samples, while formulations containing both Cu and Co exhibited the highest Na leaching. All samples demonstrated cationic dissolution and subsequent mobility of Mg. Control and Control+Cu samples presented diffuse Mg-containing bands at the visually observable corrosion front, while samples containing both Cu and Co exhibited homogeneous mobility of Mg past the visually observable corrosion layer. Similar to the behavior of Mg in Control samples, Fe forms a diffuse band at the visually observable corrosion front, yet in samples containing both Cu and Co, Fe concentrated a double-layered band at the same location. Inclusion of both Cu and Co resulted in their mobilization and formation of a band at the visually observable corrosion front (FIG. 9(b)). Cu, when included in any formulation, created a Cu-rich band, while Co accumulated as a band in the same position, albeit by lesser net intensity counts compared to Cu.

### Transition (Also Referred to Herein as Heavy) Metals Modify AAC Microstructure and Properties

Results from the desorption potential experiment indicate that a maximum of 98% of any heavy metal element (i.e., Cu, Co) was liberated by the Control+Cu and Control+Cu/Co formulations after exposure to 6 eq of acid (FIG. 4). In comparison, semi-dynamic leaching revealed lower leaching of both Cu and Co (FIG. 3). The difference in leaching behavior might indicate a complex behavior of heavy metals exposed to acidic conditions, which may relate to heavy metals compensating charges within the aluminosilicate framework. Similar heavy metal charge-compensation has been observed for multivalent heavy metals with +2 and +3 charges.

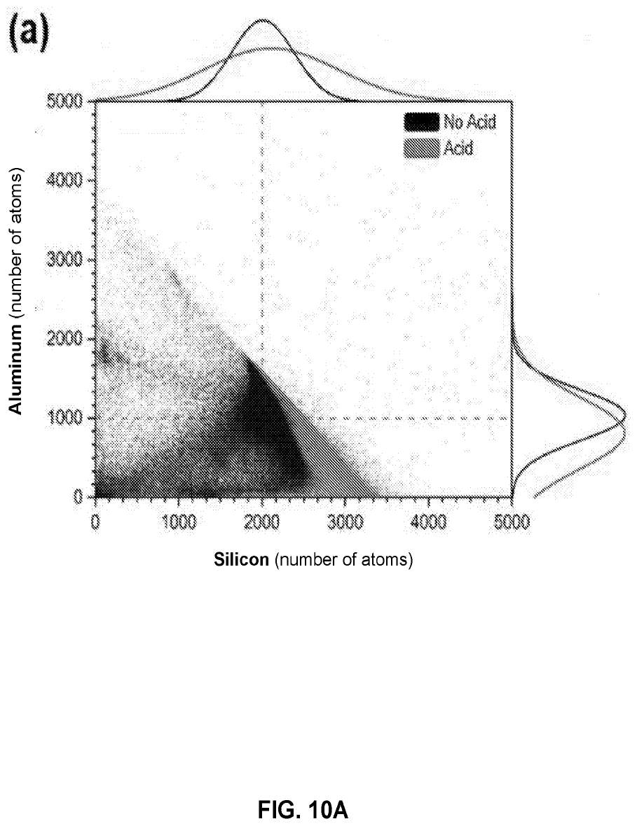

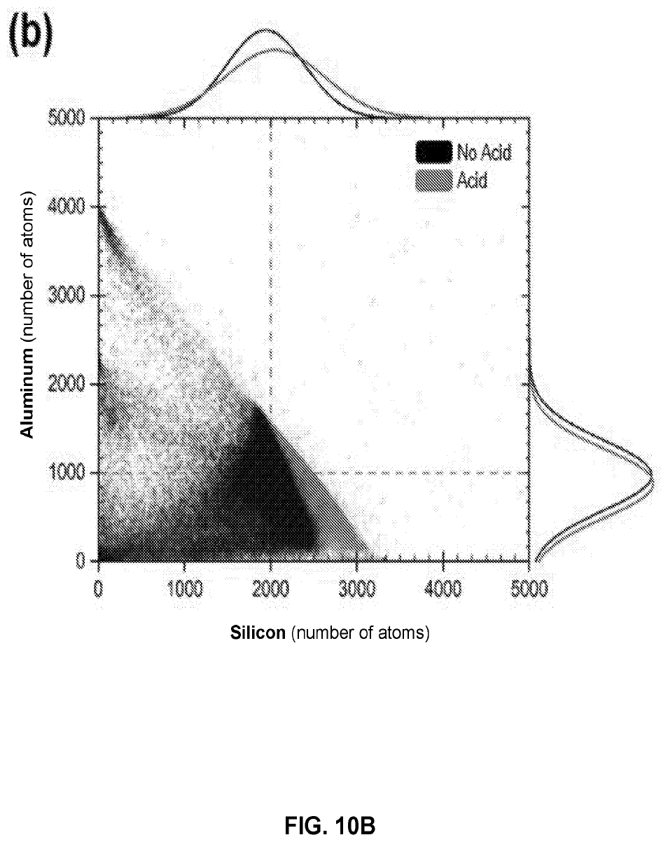

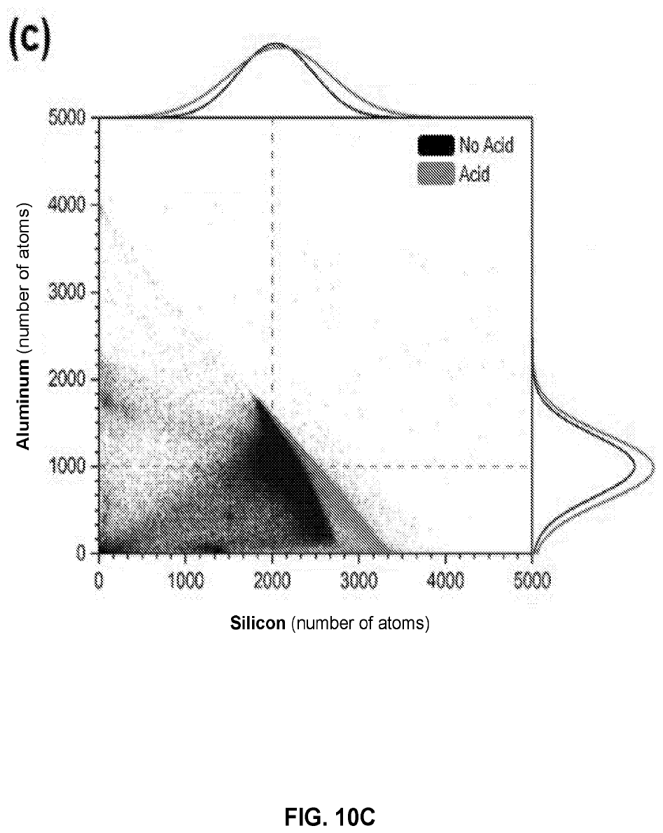

Heavy-metal modifications resulted in distinctive changes to material properties. All AAC samples herein are composed of both C—S—H (FIGS. 5 and 6) and N-A-S-H binders. This observation has been similarly observed in studies of blended systems and, in this study, it is due to presence of belite in the slag precursor and of reactive Si and Al in the metakaolin precursor (Table 1). The inclusion of Cu and Co increased elemental leaching of both Si and Na in deionized water (FIG. 3) as compared to the Control sample. Leaching of Si and Na ions in AACs may be explained by a shift in equilibrium due to chemical reactions of free silicate monomers, dimers, trimers, and alkali metals (i.e., Na). Leaching of Na from the AAC microstructure allows for the breakdown and mobility of unreacted Si monomers and oligomers. As a result, higher leaching of Si and Na indicate that Control+Cu and Control+Cu/Co samples may have higher unreacted Si content. This finding is consistent with (1) prevailing theory that suggests that heavy-metal cations (i.e., Cu, Co) aid in stabilization of negatively charged Al anions in the binder's Si—O—Al—O chain, enhancing mobility of other cations (i.e., Na), and (2) studies on NaSi gels with low Si contents (low SiO₂/Na₂O molar ratios) that revealed higher Si leaching when exposed to deionized water. Finally, the addition of heavy metals reduces dealumination of AACs as evidenced by the decreasing shifts in distributions of aluminum atoms (FIG. 10) and decreased changes to the bulk Si:Al ratios (Table 5) before and after acid exposure. Reductions in dealumination improves resistance to changes in porosity due to sulfuric acid and deionized water exposure (FIG. 7), retards gypsum formation (FIGS. 5 and 6), and reduces the observable corrosion depth when exposed to acid (FIG. 8).

TABLE 5
Bulk Si:Al ratio means and medians derived from EMPA data.

| Unexposed | | | | Acid Exposed | | | |
|---|---|---|---|---|---|---|---|
| Sample | Median | Mean | S.D. | Sample | Median | Mean | S.D. |
| Control | 1.86 | 1.9 | 0.42 | Control | 2.43 | 2.57 | 1.01 |
| Control + Cu | 1.97 | 2.02 | 0.51 | Control + Cu | 2.29 | 2.42 | 0.84 |
| Control + Cu/Co | 1.92 | 1.98 | .052 | Control + Cu/Co | 1.96 | 2.08 | 0.79 |

### Dissolution and Precipitation Reactions Due to Loss of Pore Structure

Pore structure—and the preservation of the pore solution—is hypothesized to play an important role in the dissolution and precipitation reactions occurring during exposure to aggressive solutions. Leaching of soluble phases or inducing mobility of ions in the AAC matrix enabled different mineral precipitation in acid. For example, ion dissolution yielded precipitation of gypsum when powdered samples were exposed to sulfuric acid (FIG. 6). Contrastingly, cast samples with heavy metals resulted in retarded gypsum precipitation when exposed to acid (FIG. 5). The different behavior of cast samples could be explained by the retention of the pore structure and preservation of the pore solution, which may reduce the initial dissolution and subsequent precipitation reactions. Similar observations have been reported, where fly ash-based AAC samples retaining their pore structure during deionized water exposure exhibited lack of mineral formation.

### Acid Degradation Mechanisms

While evidence consistent with prevailing acid degradation theory was observed—dealumination and decalcification—elemental mapping analysis of acid-stressed AACs containing Cu and Co indicate that other acid degradation mechanisms are possible in these materials. Differences in dealumination and decalcification were observed in the presence and absence of Cu and Co (FIG. 9). For example, dealumination progressed in Control samples with the concomitant loss of Al from the microstructure, while decalcification was observed in all samples. These results suggest that the presence of heavy metals, such as Co and/or Cu, can influence the extent and pathways of acid degradation in the following specific terms: (a) extent of H₃O⁺ penetration, (b) cationic mobility, fate, and stabilization of the AAC microstructure, and (c) formation of an acid passivation barrier.

### H₃O⁺ Penetration into the AAC Framework

Experimental evidence confirms H₃O⁺ penetration past the visually observable corrosion layer, which may be responsible for inducing cationic mobility via mineral dissolution. For example, elemental mapping of Mg and Fe reveal mineral dissolution and subsequent cation mobility upon acid exposure past the visually observable corrosion layer in any sample, as defined by the decalcification fronts observable in the Ca elemental maps (FIG. 9). In general, acid-induced mineral dissolution is caused by the presence of H₃O⁺ ions and their adsorption onto solid surfaces. The H₃O⁺-induced dissolution of Mg- and Fe-containing minerals observed herein (FIG. 5) is likely similar to the dissolution of forsterite, a magnesium silicate mineral. In acid-induced forsterite dissolution, three hydrogen atoms of a hydronium ion dissolve the mineral by associating with two bridging oxygen atoms and liberating the Mg cation. Furthermore, other studies have validated the role of H₃O⁺ ions on the dissolution of Fe-containing mineral phases. Therefore, given that H₃O⁺ ions play an important role in the occurrence and rate of both Mg- and Fe-containing mineral dissolution, its deeper presence within the aluminosilicate framework indeed would induce both mineral dissolution and cationic mobility.

### Cationic Mobility, Fate, and Stabilization of AAC Microstructure

Results indicate that the mobility of cations (e.g., Mg, Fe) within the microstructure may influence the leaching of other cations (e.g., Na). When exposed to sulfuric acid, Cu/Co-containing samples leached the most Na of all AACs (FIG. 3). Complementary to these results, FIG. 9(b) indicates the absence of Na in corroded regions. Absence of Na charge-balancing cations may be exacerbated by the mobility of other cations within the microstructure, such as Mg from merwinite minerals (FIG. 5), and potential binder charge-compensation by Cu and Co, as explained previously. For example, the quantity of free Mg cations can be observed to increase in areas of high Na leaching (FIG. 9(b)). Furthermore, in samples incorporating Cu and Co, the release of Na atoms may be preferential in these samples and, also, may not compromise acid resistance due to extensive cationic mobility of Mg, as further discussed in the following paragraph. These observations not only further provide evidence of cationic mobility past the visually observable corrosion layer, but also help explain the findings reported therein, which show that high alkali contents improve the acid resistance of AACs.

Cationic dissolution from minerals (FIG. 5) and subsequent retention of cations within the AAC framework stabilizes the binder and prevents further deterioration in acid. As previously discussed, Mg elemental maps (FIG. 9) show the dissolution of Mg mineral phases (merwinite) past the visually observable corrosion depth (decalcified front). At these same depths, cation mobility is also observed in samples incorporating Cu and Co. These heavy metal-containing samples exhibit lower porosity changes after acid challenges and yield lower amounts of corrosion product as judged by caliper measurements (see FIGS. 7 and 8). Based on these results, it is hypothesized that the released cations may act as replacements for the initial charge-balancing cations (primarily Ca and Na), whose weak bonds with Al in the binder can be replaced by hydronium ions penetrating the AAC matrix. In this context, the inclusion of diffusible Cu and Co as supplementary cations appear to play an important role in inhibiting electrophilic attack of AAC binders by H₃O⁺ ions.

### Passivation Barrier Formation

Fe, Cu, and Co cations appear to form a passivation barrier, which may help reduce the extent of dealumination and improve the acid resistance of AACs. After seven days of acid exposure, AAC samples with heavy metals concentrated in bands with other cations at the degradation front (see FIG. 9). Complementary to these results, these samples exhibited the lowest porosity changes and smallest corrosion depth compared to the otherwise identical Control samples (FIGS. 7 and 8). These observations are novel, as the role of Fe in AACs, and, especially, their role in acid degradation, has not been fully explored, with only limited studies demonstrating reductions in the local Fe coordination after alkali activation.

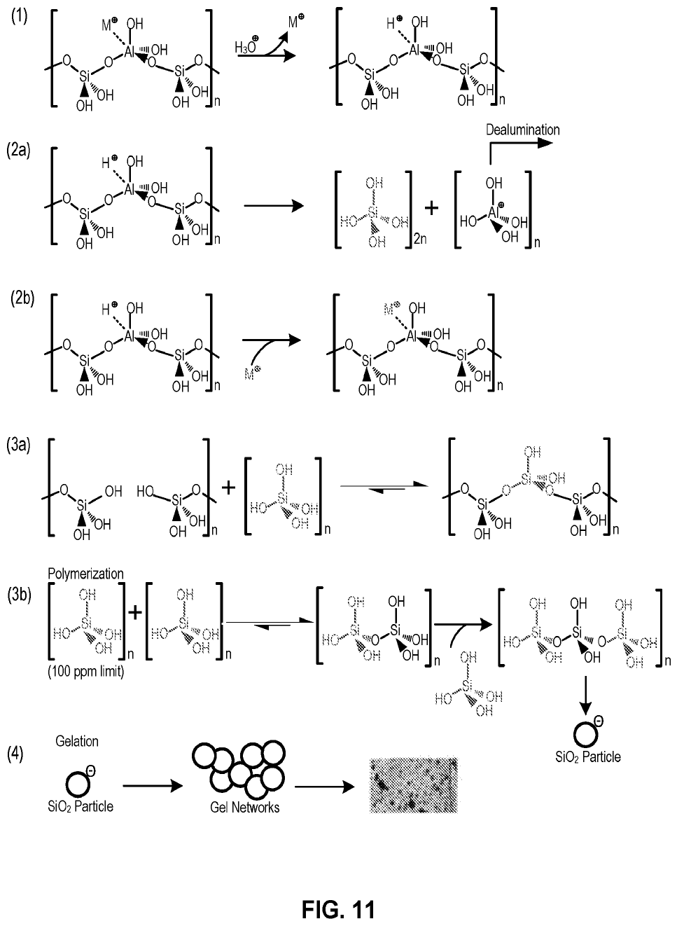

The proposed mechanism of acid degradation is illustrated in FIG. 11. Complementary to existing acid degradation theory, the presence of a passivation barrier is hypothesized to create different pH and silica concentration conditions within the AAC microstructure, which affect the stability of silica gels in acidic conditions. During acid challenges, electrophilic attack of Si—O—Al bonds by H₃O⁺ ions (reaction 1), and subsequent decalcification results in dealumination (reaction 2a). Given the data presented in this study, it is evidenced that dealumination competes with a process of cation stabilization (Mg⁺², Fe⁺³, Ca⁺²), as presented in reaction 2b and demonstrated by FIG. 9. After dealumination, formation of a protective layer of polymerized silica has been observed (reaction 3a); this gel is believed to be less porous and aids in the retention of cations, promoting acid resistance. Previously, a set of balanced equilibrium reactions was proposed to describe the polymerization of silica species and subsequent formation of silica gels at low pH values. However, the polymerization and, later, gelation of silica species is a pH- and concentration-dependent process based on chemical equilibrium, which has not been previously considered. The fundamental chemistry of silica has previously been explained in detail, where polymerization of silica at pH 2-7 is described in the following steps: (1) polymerization of silica monomers (orthosilicic acid) to dimers, trimers, cyclic oligomers, and particles, (2) slow particle growth reaching a diameter of 2-3 nm, and (3) collision or aggregation of silica particles into chains and then gel networks. The aforementioned steps are limited by the concentration of orthosilicic acid monomers in solution, which, if maintained above its solubility concentration limit, permits silica polymerization and particle growth, as described by nucleation theory (reaction 3b).

The presence of multivalent cations (e.g., Mg⁺², Fe⁺³, Ca⁺², Co⁺², Cu⁺² and other cations noted herein) within the AAC microstructure affects both (1) the stability of silica species and (2) pH conditions, which may be further promoted via creation of the passivation barrier. As a result, these two concurrent conditions may permit the formation of stratified silica gels. The heavy metals in solution favor the stability of polymeric silica species and retard depolymerization into orthosilicic monomers. The higher stability of polymeric silica species may enhance silica mobility to the periphery of AAC samples as facilitated by diffusion (FIG. 9). Subsequently, depending on the concentration, the presence of multivalent cations (e.g., Mg⁺², Fe⁺³, Ca⁺², Co⁺², Cu⁺² and others, such as those illustrated in FIG. 12) decreases the rate and size of silica particle aggregation due to silica particle stabilization. The semi-dynamic leaching data, presented in FIG. 3, demonstrates lower leaching of multivalent cations. These results suggest that particle aggregation size and rate is decreased, which may further enhance the mobility of smaller silica particle aggregates to the periphery of the material. As silica species mobilize to the periphery, if the pH within the AAC microstructure is lower, then polymerization of silica monomers (reaction 3b) and gelation of silica particles (reaction 4) is expected to increase. Additionally, the former two conditions (silica stability and pH) may be further maintained by the formation of the passivation barrier, thus, aiding the stratified formation of silica gels at the periphery (FIG. 9). Benefiting the acid resistance of AACs, the formation of silica gels may serve as an adequate protective, non-porous, and impermeable layer. Inversely, in AAC samples without heavy metals, previously mentioned pH or silica conditions may not be present due to the lower content of multivalent cations and absence of a passivation barrier. Instead, sporadic and randomized gelation may be preferred throughout the AAC microstructure (FIG. 9). In summary, the experimental evidence presented here suggests an alternate pathway for the formation of a stratified silica-rich gel in the presence of heavy metals during acid degradation—one that depends on the presence of multivalent cations, pH conditions, and silica speciation.

In summary,
AACs micro-doped with transition metals, such as Cu and Co, inhibited the rate of calcium sulfate mineral formation, resulting in lower permeable porosities and smaller corrosion depths;
Hydronium ions were evident within the AAC framework and extended beyond the visually observable corrosion front;
Hydronium ion penetration was associated with increased cation mobility; mobile cations aided in the stabilization of cementitious binders;
Metals, such as Fe, Cu, and Co ions, formed passivation barriers at the acid degradation front, suggesting they play a critical role in reducing the extent of dealumination and improving the acid resistance of AACs;
A stratified silica-rich gel was observed in AACs containing Cu and Co; the formation of this gel is likely dependent on the presence of multivalent cations, pH conditions, and silica speciation.
Together, these data provide new experimental evidence of a more complex AAC acid degradation mechanism than previously observed.

In addition, it was found that mineral formation and stabilization pathways in MK-based AACs may be dependent not only on Si:AI ratio, but also on both silica availability and alkali content. The time dependent XRD patterns and NMR spectra, in concert with characterization of bulk physical properties, show that these mineralization and stabilization pathways can have adverse effects on bulk physical properties. For example, the early formation and growth of silicon-rich minerals or the existence of a predominant silicon-rich amorphous phase coincided with reductions in bulk permeable porosity. However, late-age crystallization (amorphous-to-crystalline) and solid-solid (crystalline-to-crystalline) mineralogical transformations, which were observed, both led to increases in permeable porosity. These results demonstrate the importance of understanding and, ultimately, controlling the mineral formation and stabilization dynamics in MK-based AAC systems.

Similar work elucidated the effect of heavy-metal (ferric) mineral admixtures on the acid resistance of geopolymer materials. Prior to acid exposure, material characterization revealed the following mineralogy, molecular and hardened-state property results. As expected, increasing the sodium content yields the formation of silicon-rich phases, such as faujasite, and increases the extent of N-A-S-H binder network formation. No evidence is observed for the Fe modification of the geopolymer cementitious binder. Instead, weak ITZ phases between the cementitious binder and ferric mineral admixture may decrease the compressive strength and increase the content of micro-sized pores, as well as increase aluminum incorporation.

Upon acid exposure, ferric mineral admixtures are observed to (1) minimize compressive strength loss, (2) minimally participate in acid buffering, (3) increase micro-size porosity, and (4) participate in Fe-(Si, Al) phase interactions. These converging lines of evidence provide indication for the acid resistance imparted by the addition of ferric mineral admixtures. Supplemented geopolymer samples exhibit minimal compressive strength loss than their non-supplemented counterparts. This acid resistance is attributed to an increase in micro-sized pore structure with ferric mineral admixtures, which decreases diffusion-driven hydric-mechanical forces. Moreover, ferric mineral admixtures slightly increase the acid neutralization (buffering capacity). Both effects yield a higher acid resistance of the material due to changes in the silica gel-network formation (Si:Fe ratio) and the microstructural Fe—Al interactions. An increase in the Fe:Al ratio within the materials microstructure has plausible explanations, some of these are the (a) isomorphous substitution in precipitated phases, (b) silica gel network interactions, or (c) polyvalent cationic stabilization. In conclusion, geopolymer cements supplemented with ferric mineral admixtures are, in general, of higher acid resistance, especially when formulated at high sodium contents. These results are critical for the development of high acid resistant geopolymer materials.

Yet additional work elucidated the effect of light-metal (e.g., group 2 metals) (Mg) mineral admixtures (i.e., Mg(OH)₂, brucite) on the acid degradation of low-calcium AACs. Prior to acid exposure, high sodium content formulations demonstrated a higher content of nano-sized porosity, as well as high non-connected micro-size porosity. As expected, these samples also exhibited the formation of faujasite and similar Mg:Al ratios, when compared with supplemented low sodium content formulations.

Upon acid exposure, Mg mineral admixtures are observed to (1) increase the buffering capacity of AACs, (2) increase Mg:Al ratio of the microstructure, (3) reduce the appearance of cracking or sample failure, and (4) minimize changes in porosity. These converging lines of evidence provide indication of the acid resistance imparted by Mg mineral admixtures. Chemical microstructural characterization revealed increases in the Mg:Al ratio upon acid exposure due to MgOH₂⁺ surface site interactions with Al ions or possibly cationic (i.e., Mg+2) stabilization of Si—O—Al bonds. Moreover, Mg admixtures have been shown to increase the pH value at equilibrium of initially acidic solutions. High pH values (i.e., higher buffering capacity) are related to a decrease in both micro- and nano-scale porosity changes for AACs supplemented with Mg mineral admixtures. Minimal further development of porosity after 4.2 hours of sulfuric acid exposure is observed for supplemented AAC samples. In conclusion, low-calcium AACs, when supplemented with Mg mineral admixtures, are, in general, of higher acid resistance, especially when formulated at high sodium contents.

Acid buffering capacity of cementitious materials is a beneficial durability quality originating from the dissolution-precipitation reactions occurring under acidic conditions. However, as observed herein, the buffering capacity of metakaolin-based (low-calcium) AACs has been demonstrated to be minimal due to the absence of chemically active solid phases (i.e., supplemental ions). Consequently, the material is prone to shrinkage cracking due to the formation of silica gels, which aggregate at the edge of the material. Addition of heavy and light metal ion additions is observed to result in microstructural ion mobilization, permitting the formation of passivation barrier at the corrosion front, observed mainly for Cu+2/Co+2 ions, or ion-aluminum pairing, observed for Fe+2/+3 and Mg+2 containing species. The presence of such microstructural features was correlated with increased acid resistance of the low-calcium AACs, especially at high sodium content formulations (Na:Al=1.39), in the form of decreased dealumination, compressive strength loss, and permeable porosity.

The presence of light or heavy metals within the cementitious microstructure improves the acid resistance of low-calcium AACs, as it may stabilize the sites electrophilically attacked by protons—this mechanism has been named polyvalent cationic stabilization. This proposed mechanism is dependent on the ionic size, speciation, charge and local availability. Because the chosen heavy and light metal ions have both similar ionic charge and ionic radii (Mg+2≈Cu+2≈Co+2<Fe+2; 72 pm, 73 pm, 74.5 pm, 78 pm), their local availability and speciation are thought to play significant roles in the acid resistance responses observed. For example, acidic conditions present thermodynamically favorable conditions to form cationic sulfate species, such as iron sulfates (e.g., FeSO⁴⁺) when iron-based mineral admixtures are present. Similarly, in the presence of magnesium-based mineral admixtures, magnesium sulfate salts are expected to form with high solubilities (113 g/100 mL) and, hence, can be present as dissociated divalent cations (Mg+2). SEM-EDS and WDS data of the acid exposed internal microstructure correlated an increase in the M+:Al ratio, where M+ is Fe+2/+3 or Mg+2 containing ionic species, with increased material acid resistance, such as lower dealumination, compressive strength loss, corrosion depth, visual degradation, and permeable porosity. These results have enabled new scientific queries on the role of ionic species stabilization of acid-exposed low-calcium AACs, as well as various other cementitious materials.

The formation of such beneficial (and detrimental) zeolitic phases can be dependent on both the alkali content of the AAC formulations, which can determine silicon speciation, and the hydrothermal curing conditions, which establishes thermodynamic conditions for mineral growth. These two factors affect mineral dynamics by dictating early-age and rates of mineral formation, as well as the metastability of the zeolitic phases formed. Consequently, silicon-rich mineral formations were associated with reductions in permeable porosity—a relevant material property for diffusion of aggressive agents causing chemical attack, sulfate attack, or carbonation.

Given the results from acid degradation provided, no significant effect from expected zeolitic mineral formation has been identified on the durability of low-calcium AACs. The initial formation of faujasite was expected due to the partial hydrothermal processing conditions and high sodium contents (Na:Al=1.39) in all low-calcium AACs tested. However, no acid resistance benefit was correlated with faujasite formation, which likely has a limited participation in the acid dissolution-precipitation reactions occurring within the material.

Further studies showed that sulfuric acid resistance of low-calcium alkali-activated materials (i.e., geopolymers) supplemented with an iron mineral admixture (i.e., hematite). Geopolymers without and with 5% hematite were produced at two alkali contents (Na:Al=0.86 and 1.39) and yielded increased acid neutralization capacity.

### Additional Examples

### Materials

Metakaolin (MK) (MetaMax) was supplied by BASF Chemical Corporation (Georgia, USA). The chemical composition of MK was determined by ICP-OES to be 54% and 47% by weight SiO₂ and Al₂O₃, respectively. Hematite (Fe₂O₃) was supplied by Strem Chemicals Inc. with a chemical purity of 99.8%. Alkali-activating solutions were prepared using sodium hydroxide (Sigma-Aldrich, NaOH≥97%) and sodium silicate (Sigma-Aldrich, SiO₂=27 wt. %, Na₂O=11 wt. %). Sulfuric acid solution with a pH of 2.0±0.07 was prepared by adding sulfuric acid (Sigma-Aldrich, H2SO4≥95%) to deionized water.

### Experimental Methods

### AAC Sample Preparation

Geopolymer samples were produced with two alkaline activators to achieve Na:Al atomic ratios of 0.86 and 1.39 with a uniform Si:Al atomic ratio of 1.15 (see Table 6). Alkali-activating solutions were prepared in high-density polyethylene bottles, which were sealed and cooled for one hour at 4° C. to enable the NaOH exothermic reaction to subside. The effect of iron mineral admixtures was explored with the addition of 5 wt. % of hematite to simulate an iron-rich laterite clay. MK was alkali-activated with the respective alkaline solutions and mixed for three minutes with one minute of manual mixing, one minute of mechanical mixing, followed by one final minute of manual mixing. Mixtures achieved a homogenous consistency after the mixture procedure and were placed in Vaseline-lubricated molds (diameter: 13 mm, height: 25 mm). Subsequently, mixtures were tamped for 30 seconds and vibrated for 30 seconds until visible entrapped air was removed. Paste samples were then cured in sealed containers (99% RH) in a Quincy forced air laboratory oven for 48 hours at 40° C. After initial curing, samples were dried at 40° C. for an additional 24 hours.

TABLE 6
Mixture proportions for MK-based AAC control and iron supplemented samples.

| | Constituent Materials | | | | | Important Parameters | | |
|---|---|---|---|---|---|---|---|---|
| Sample Name | MK (g) | Fe₂O₃ (g) | NaSi (ml) | NaOH (g) | H₂0 (ml) | Fe (%) | Si:Al | Na:Al |
| Control Low | 50 | 0 | 13 | 13 | 33 | 0 | 1.15 | 0.86 |
| Control Low + Fe | 50 | 2.6 | 13 | 13 | 33 | 5 | 1.15 | 0.86 |
| Control High | 50 | 0 | 13 | 22 | 33 | 0 | 1.15 | 1.39 |
| Control High + Fe | 50 | 2.6 | 13 | 22 | 33 | 5 | 1.15 | 1.39 |

### Equilibrium-Based Acid Exposure and Leaching

Samples were exposed three times to a sulfuric acid solution with a pH of 2.0±0.07 until pH equilibrium was attained (<0.0025 pH/hour). Following a modified ASTM C1308 methodology, samples were suspended using a 46 mm Savillex support screen (730-0046) and constantly stirred in the acid solution. The volume-to-surface-area ratio of the solution and AAC sample was held constant at 10. A magnetic stirrer was used to ensure homogenous solution mixing. pH equilibrium was defined as the time in which the recorded change in pH was <0.0025 per hour. After equilibrium was reached, the acid solutions were replaced, and samples of the leachate media were analyzed via ICP-MS. Triplicates of each sample were exposed to acid and aliquots were taken at each equilibrium point.

### Fourier-Transform Infrared Spectroscopy (FTIR)

Unexposed and exposed samples were ground in a slurry of ethanol using a McCrone micronizing mill with yttrium-stabilized zirconium (American Elements) grinding beads for five minutes to achieve particle sizes <5 μm. Collected slurries were dried overnight at 60° C. Next, 0.02±0.005 grams of each sample were mixed with 2.00±0.050 grams of potassium bromide (KBr) powder and dried at 70° C. Then, the powder mixtures were homogenized in a Spex Grinder mill and pressed into KBr disk pellets for analysis in a Thermo Scientific Nicolet iS10 FTIR Spectrometer. As a result, KBr disks with sample concentrations of 1% (by weight) were produced. Disks were analyzed against a blank background to remove the absorption spectra from the chamber purged with nitrogen.

### Energy Dispersive Spectroscopy (EDS)

The silicon (Si:Fe) and iron (Fe:Al) content of each unexposed and exposed sample were quantified by analyzing the Si Kα, Al Kα, and Fe Kα, which were obtained using a JEOL-8230 electron microprobe with a Thermoscientific energy dispersive spectrometer (EDS). An acceleration voltage of 15 keV and beam current of 20 nA was used for all acquisitions. EDS acquisition was standardless, using a spectral acquisition of 15 seconds, which was sufficient to accumulate counts over 4000. A ZAF correction for the elemental matrix was performed in all acquisitions. Twenty randomized points were collected for five different locations in all samples (top, bottom, center, left, and right), totaling an acquisition of 100 EDS points per sample. Atomic percentages were quantified and used to discern the central tendencies of bulk Si:Fe and Fe:Al ratios.

### X-Ray Diffraction (XRD)

Mineralogy was determined via semi-quantitative X-ray diffraction (XRD) using Cu Kα radiation (Siemens D500 X-ray diffractometer). In this methodology, corundum (American Elements) was used as an internal standard to normalize peak heights between samples and align diffraction patterns. AAC samples were powderized and homogenized using a micronizing mill with well-packed yttrium-stabilized zirconium grinding beads. After samples were ground, samples were homogenized in plastic scintillation vials with three Delrin balls. 500 μL of Vertrel cleaning agent (Miller-Stephenson) were added to vials in order to generate aggregates with random particle orientation. Subsequently, samples were sieved through a 250 μm mesh and packed into XRD analysis plates. Samples were then analyzed from 5 to 65 degrees 2θ using Cu Kα X-ray radiation with a step size of 0.02 degrees and a dwell time of 2 seconds per step. Mineralogy was identified using Jade software (MDI, Version 9) and the International Centre for Diffraction Data (ICDD) 2003 database.

### Micro-Computerized Tomography (□-CT)

AAC samples before and after acid exposure were analyzed in a Zeiss Xradia 520 X-ray microscope. Acid-exposed samples were dried in a laboratory oven for at least 12 hours at 40° C. prior to imaging. A micro-computerized tomograph was produced using the 0.4× objective with X-ray source parameters of 60 kV acceleration voltage and 5 Watts. A LE2 filter was utilized to reduce the transmission values between 26% and 40% and maintain intensity counts above 5000. A pixel size resolution of 6.143±0.38 μm was achieved utilizing a pixel averaging of bin one during the acquisition. The tomography images (size: 1.2 cm×1.1 cm) were reconstructed using a Zeiss reconstruction software to adjust for center-shift and beam hardening artifacts. In addition, ring artifacts from the images were removed using a high-contrast removal operation, as well as a despeckling operation to remove pixel defects in the images. Prior to pore-structure segmentation, performed using Dragonfly 3.5, the 32-bit tomography images were pre-processed to correct for noise and uneven grey values within the image. First, a local entropy minimization (node: 9, count: 2) was performed to correct for non-uniform illumination and counteract noise by reducing randomness. Second, an open mathematical morphology operation was performed with a cross structuring element (kernel size: 9) to smooth images and remove isolated pixels. Finally, a median-based smoothing operation was performed to equalize the grey-levels of the image and remove salt-and-pepper noise. Prior to quantification, features of <1 μm were removed, as these could not be resolved given the pixel-size resolution.

### Compressive Strength

An Instron 5869 universal and an MTS Exceed E43-504 (Tension/Compression) testing machine with a 10,000 lb load cell was employed to test the compressive strength of AAC samples. In order to ensure proper flat testing surfaces, both top and bottom surfaces of AAC samples were smoothed employing 1200 and 2000 abrasive grit sheets. Acid-exposed samples were also tested after two acid exposure cycles. KimWipes™ were used to ensure a saturated surface-dry testing condition. Surface smoothing of these samples was not employed to ensure minimal sample damage. As a result, the compressive strength reported here is likely a conservative measurement of the mechanical properties. All samples were dimensioned before testing in the load cells and compressed via displacement-controlled loading.

### Results and Discussion

### Mineralogy and Molecular Structure Prior to Sulfuric Acid Exposure

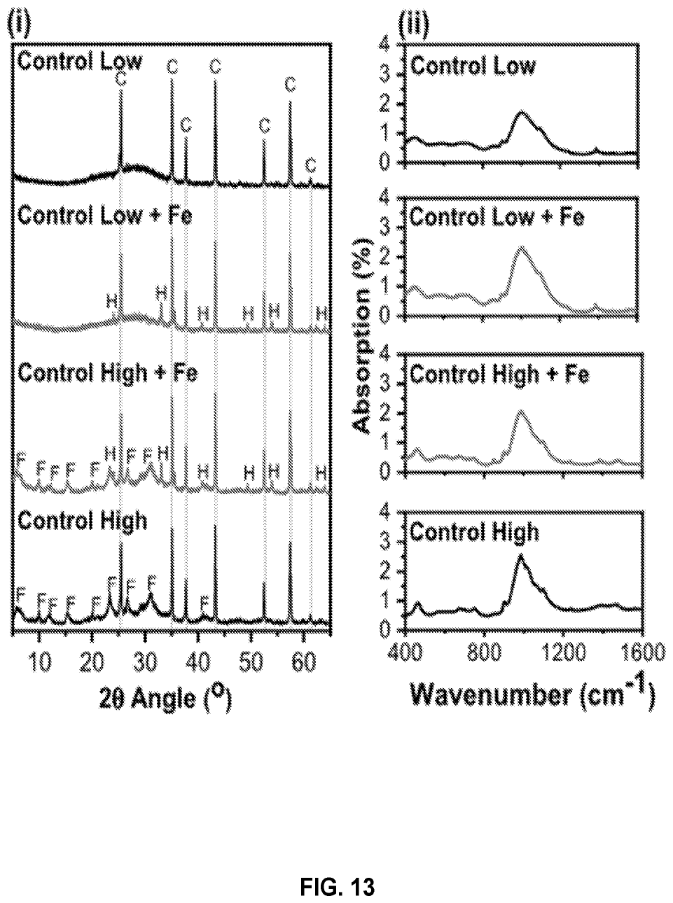

Regardless of Fe content, Control High samples form faujasite (FIG. 13(i)), while Control Low samples do not exhibit mineral formation, as expected. The presence of faujasite in geopolymer materials, which is well documented, is known to depend on silica availability, alkali content, processing, and curing conditions (i.e., temperature, humidity). The elevated temperature and humidity during curing, along with high concentration of Na+ cations in the Control High samples, thermodynamically favor formation of faujasite minerals. The inventors have found that the mineralization process depends mainly on hydrothermal curing conditions, time, and Na+ content, which impacts silica availability during geopolymerization. The mineralization of the aluminosilicate binders is important for acid resistance, as it can lower porosity and increase strength in comparison to unmineralized formulations of equal stoichiometry.

Control High samples without and with Fe have a higher degree of N-A-S-H crosslinking compared to lower Na:Al counterparts as a consequence of higher alkalinity. Also observed by others, higher precursor dissolution is to be expected, due to a higher concentration of Na+ cations. Consequently, in Control High samples, there is an increase in Al content and formation of a highly crosslinked geopolymer binder (i.e., N-A-S-H). This is evidenced in FIG. 13(ii) by shifts to lower wavenumbers of both the main Si—O—Al band (1002-1005 cm⁻¹) and the Si—O—Al symmetric-stretching band (720 cm⁻¹) to 984 cm⁻¹and 670 cm⁻¹, respectively. This observation is further supported by strong peaks for in-plane stretching and bending of Si—O and Al—O (460 cm⁻¹), symmetric vibrations of Si—O—Al and Si—O—Si bonds (750 cm⁻¹), and stretching vibrations of Al—O and Si—O tetrahedral (900 cm⁻¹). Control Low samples yield lower absorption intensities for these peaks, signifying lower degrees of reactivity and N-A-S-H crosslinking. Lastly, the presence of carbonates is confirmed for all samples by peaks at 1384 cm⁻¹ and 1560 cm⁻¹, which correspond to O—C—O asymmetric stretching.

No evidence was observed herein to indicate presence of a Fe-modified N-A-S-H cementitious binder (i.e., Fe—O—Si bonds). Current research has produced high-Fe alkali-activated materials from Fe-rich aluminosilicate precursors, such as laterite clays, Bayer red mud waste, and fayalitic slags. Contentious evidence has suggested, however, that high Fe content can result in (1) Si—O—Fe incorporation into the geopolymer network or (2) segregated formation of Fe octahedral phases. Some suggest that the consumption of Fe mineral phases leads to isomorphic substitution of Al by Fe ions, which possibly occurs in extremely distorted sites of gel-like phases. On the contrary, results from other studies found no significant structural changes induced by hematite in similar metakaolin-based AACs. The present inventors observed no structural evidence of Fe—O—Si bond formation via FTIR. In geological literature, FTIR bands at 475 cm⁻¹-487 cm⁻¹; 568 cm⁻¹-597 cm⁻¹; 1010 cm⁻¹-1030 cm⁻¹; and, 1007 cm⁻¹-1012 cm⁻¹ are used to indicate Fe—O-T (T=Al, Si, Fe) bonds. However, these FTIR assignments have been based primarily on geological investigation of iron-containing minerals (e.g., lepidocrocite, nontronite, ferrihydrite, and silica-rich ferrihydrites), which can significantly differ in their petrogenesis conditions when compared to alkali activation (i.e., pH, temperature, pressure, ionic speciation). This interpretation of geological literature agrees with geochemical principles, as the solubility of Fe+3/+2 ions in highly alkaline environments has been shown to be low, thus supporting the argument that Fe—O-T bonds are unlikely to form upon alkali-activation.

### Mineralogical and Structural Effects of Sulfuric Acid Exposure

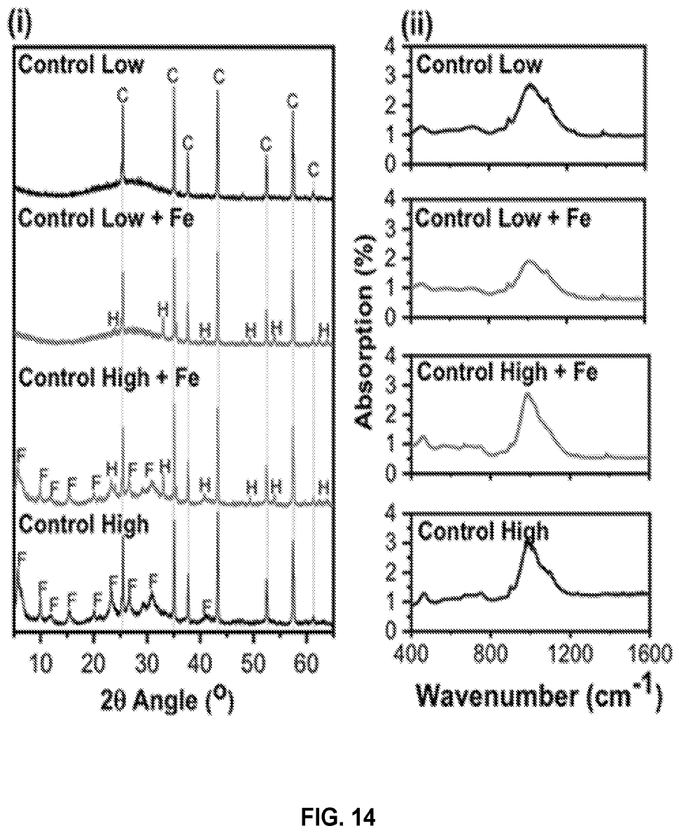

After acid exposure, the mineral composition of all geopolymer samples remains largely identical to unexposed samples. Increases in faujasite formation were observed in samples with high alkali contents (FIG. 14(i)). As expected, a loss of carbonates, Si, and Al was evidenced by FTIR band intensities (FIG. 14(ii)). Carbonates are expected phases in N-A-S-H binders, due to the carbonation of alkalis (e.g., Na+) that remain after activation. In all geopolymer samples, carbonates likely dissolved in the low pH induced by sulfuric acid. This dissolution is evidenced in FIG. 14(ii), as an intensity decrease in the 1384 cm⁻¹ and 1560 cm⁻¹ peaks, which correspond to O—C—O asymmetric stretching in carbonates. The consumption of carbonates is expected to aid in arresting the protic dissolution of the Si—O—Al binder by serving as a pH buffering agent. Loss of Si and Al is represented by an intensity decrease in the main Si—O-T band (1002 cm⁻¹) and other Si—O—Al symmetric stretching vibrations (670 cm⁻¹, 600 cm⁻¹, and, to a lesser extent, 590 cm⁻¹). These observed changes, coupled with an intensity decrease of the Si—O bending mode observed at 450 cm⁻¹, indicates the loss of aluminum (i.e., dealumination) of the N-A-S-H binder and subsequent loss of Si as a consequence of acid attack. Control Low samples demonstrate slightly lower dealumination when compared to their Fe-supplemented counterparts, as substantiated by a higher intensity absorption band at 1002 cm⁻¹ (Si—O-T). However, Control High samples with hematite addition remain largely unchanged after acid exposure, as evidenced by an increase in the main Si—O-T band (1002 cm⁻¹) intensity. The increase in Si—O-T band intensity may reflect a reorganization of the cementitious binder and increased formation of faujasite within the geopolymer material, as verified by an increase in relative diffraction peak intensity (FIG. 14(i)).

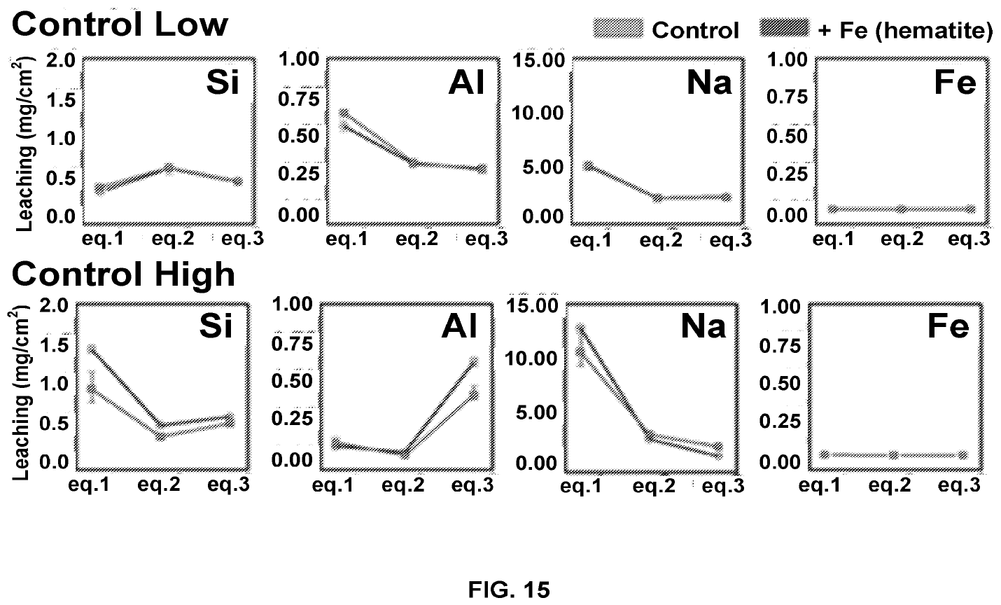

Ion leaching profiles collected after three repeated sulfuric acid exposures are shown in FIG. 15. Control Low samples without and with hematite addition bear no significant differences in Si, Na, and Fe leaching. However, slightly lower dealumination in the Control Low samples without hematite addition was observed. This result was supported by evidence obtained via FTIR (FIG. 14(ii)). Contrastingly, Control High samples supplemented with hematite demonstrate up to 50% and 33% reductions in Si and Al leaching during acid exposure, respectively, confirming that hematite addition improves the acid resistance of these samples. The retention of these framework metals further substantiates the preservation of the Si—O—Al bonds in the N-A-S-H cementitious binder and possible formation of Si—O—(Si) gels—a result also substantiated by FTIR data. Na leaching in these samples is observed to be slightly higher at the third acid exposure. This result may indicate that Fe species could displace Na from local negative moieties (Al) in the N-A-S-H binder due to a higher chemical affinity.

The acid neutralization capacity of geopolymer samples after the first and second acid exposure is temporarily improved by an increase in hematite and alkali content (see Table 7). The acid neutralization capacity of samples is an important material property, as it demonstrates the ability of a material to buffer the pH of an acidic medium. The first acid exposure reveals that alkali content increases the acid neutralization capacity with higher final pH values for Control High formulations (12.43, 12.36) when compared to Control Low formulations (10.23, 10.59). As expected from earlier work on acid degradation of cementitious materials. After the second exposure, the addition of hematite increased the final pH from 4.10, as achieved by the Control High samples, to 5.27. This increase is likely due to the dissolution of hematite, since lower Si leaching and minimal differences in dealumination are observed. However, by the third exposure, the acid neutralization capacity imparted by hematite is negligible. Minimal changes to the final pH were observed between samples without and with hematite (i.e., 3.81 vs. 3.99). These data show that the acid resistance benefits of the Control High samples supplemented with Fe described by the mineralogy, molecular structure, and leaching data are not thought to be solely due to the acid buffering capacity of hematite-containing samples.

TABLE 7
Final pH value at each equilibrium exposure
for all sample formulations.

| | Acid Exposure | |
|---|---|---|
| Sample Name | Cycle | Final pH |
| Control Low | 1 | 10.23 |
| | 2 | 3.96 |
| | 3 | 3.96 |
| Control Low + Fe | 1 | 10.59 |
| | 2 | 3.95 |
| | 3 | 4.09 |
| Control High | 1 | 12.43 |
| | 2 | 4.10 |
| | 3 | 3.81 |
| Control High + Fe | 1 | 12.36 |
| | 2 | 5.27 |
| | 3 | 3.99 |

### Physico-Mechanical Changes After Sulfuric Acid Exposure

Table 8 summarizes the observable (>6 μm) segmented porosity of geopolymer samples before and after sulfuric acid exposure. The porosity of Control Low samples without and with Fe approximately doubled upon exposure to acid, thus confirming previous FTIR,

XRD, and leaching results that, at low alkali contents, hematite addition reveals a negligible benefit to acid resistance. Increasing alkali content of geopolymer formulations, regardless of hematite addition, yields an increase in the original observable porosity. Upon sulfuric acid exposure, however, Control High samples with hematite additions do not reveal a significant change in porosity (1.11%). Hence, the changes to the molecular structure (i.e., Si-rich gel formation and Si—O—Al preservation) minimally affect the porosity of Control High with hematite samples. Control High samples without hematite, however, failed after acid exposure, probably due to the small sample size required for μ-CT analysis. The sample geometry may have increased the rate of deleterious sample desiccation and produce destructive diffusion-driven hydro-mechanical forces.

TABLE 8
Cumulative visible porosity (>6 μm) as determined by μ-CT
scans of unexposed and acid exposed geopolymer samples.

| Sample Name | Unexposed | S.D. | Exposed | S.D. |
|---|---|---|---|---|
| Control Low | 0.73% | 0.01% | 1.30% | 0.13% |
| Control Low + Fe | 0.62% | 0.01% | 1.29% | 0.09% |
| Control High | 1.09% | 0.02% | NA* | NA* |
| Control High + Fe | 1.11% | 0.03% | 1.11% | 0.03% |

*Sample failed.

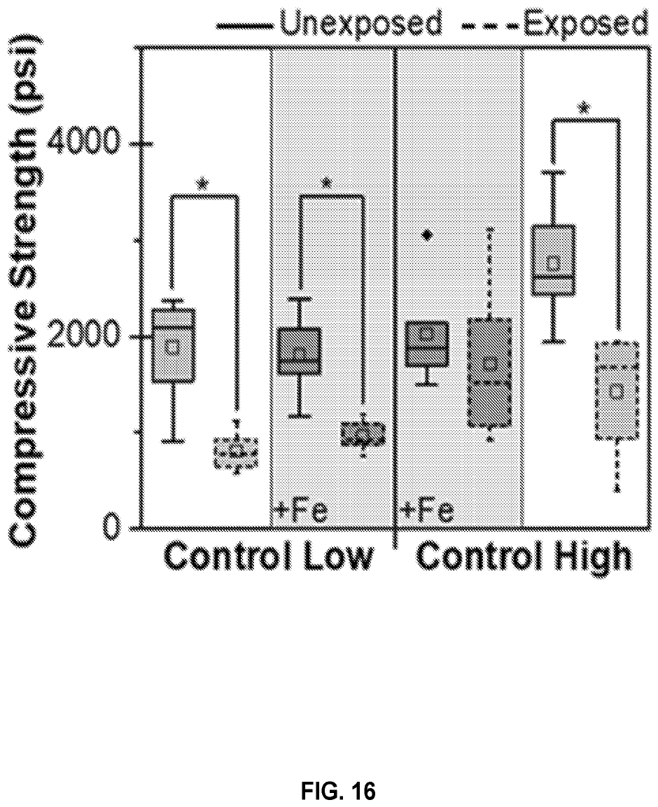

The compressive strength of all geopolymer samples before and after acid exposure is shown in FIG. 16. For low Na:Al ratio samples, similar compressive strengths are observed prior to and upon acid exposure. Thus, no significant effect on the acid resistance was found for hematite supplements at low Na:Al formulations. This result corroborates previous experimental results obtained for low Na:Al samples. Aside from the slightly higher dealumination of Control Low with hematite samples, the Control Low samples with and without hematite do not differ significantly in molecular structure, mineralogy, observable porosity or, as evidenced in FIG. 16, compressive strength.

Increasing the Na:Al content yields increased compressive strengths for geopolymer samples, as expected higher degrees of binder crosslinking (FIG. 13(ii)). Hematite addition, however, reduced the unexposed compressive strength by ˜29% in Control High samples. Recent research has demonstrated similar effects on mechanical performance, attributing iron phases with the formation of weak interfacial planes between the mineral and cementitious matrix. Once acid-exposed, the compressive strength is not significantly affected for Control High samples with hematite, indicating improved acid resistance. These results reveal the synergistic acid resistance benefits of higher alkali contents (Na:Al=1.39) and hematite (5 wt. %). Contrastingly, compressive strength decreased by ˜36% in the Control High samples without hematite upon exposure to acid.

### Mechanisms of Acid Degradation in Geopolymers with Iron Mineral Admixtures

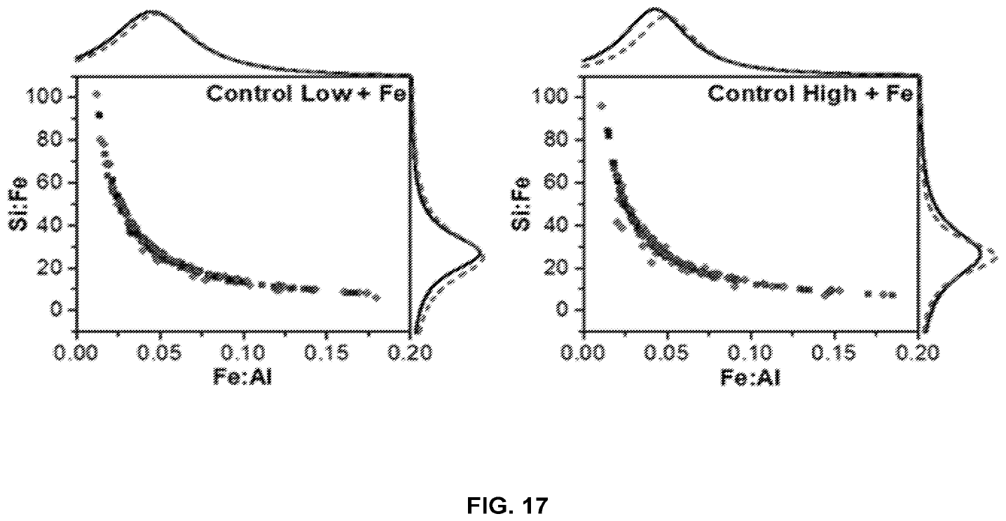

Results from EDS chemical mapping (see FIG. 17) suggest that hematite has minimal effect on the chemical distribution of Si in the microstructure when geopolymers are exposed to sulfuric acid. As observed in FIG. 17, Fe-supplemented Control Low and Control High samples exhibit a slight decrease in the Si:Fe atomic ratio mean value. This decrease in the Si:Fe ratio may indicate Si:Fe interactions as found in previous work and may be associated with Fe stabilization/destabilization of silica sols during the silica-rich gel formation process. Fe—Si interactions in aqueous solution have also been previously described by, and recent results by X-ray absorption fine structures (XAFS) spectroscopy demonstrate that, with increasing pH (2.7<pH<13), Fe may partially substitute for Si in the tetrahedral network of silica polymers. Such incorporation is a product of surface polycondensation of hydroxyl units and, hence, the formation of Fe—O—Si bonds. However, no evidence for the presence of these bonds was resolved by FTIR spectroscopy in this study (FIG. 14(ii)). Thus, this hypothesis cannot necessarily be disproven.

Control High samples with hematite exhibit improved acid resistance, as evidenced by minimal changes to the mineralogy (FIG. 14), molecular structure (FIG. 15), porous structure (Table 8), and mechanical performance (FIG. 16). These acid resistance improvements are associated with a slight increase in the Fe:Al ratio within the microstructure (FIG. 17). The increase in Fe—Al pairing found with EDS data reveals the presence of a beneficial acid resistance mechanism besides acid neutralization capacity, which is rendered null by the third acid exposure (Table 7). Chemical evidence gathered by EDS demonstrates increases of the central tendencies (i.e., median, mean) for the Fe:Al ratio after sulfuric acid exposure (FIG. 17). The formation of thermodynamically favorable Fe cationic molecules (e.g., FeSO4+) may result in association with negatively charged moieties of the aluminosilicate network (Si—O—Al). As evidenced by leaching (FIG. 15) and FTIR data (FIG. 14), dealumination occurs in these samples, which creates a concomitant increase in negative moieties during protic electrophilic attack. During this process, the electrophilic attack may be arrested if released cationic species can stabilize the unstable negative moiety of the Si—O—Al network.

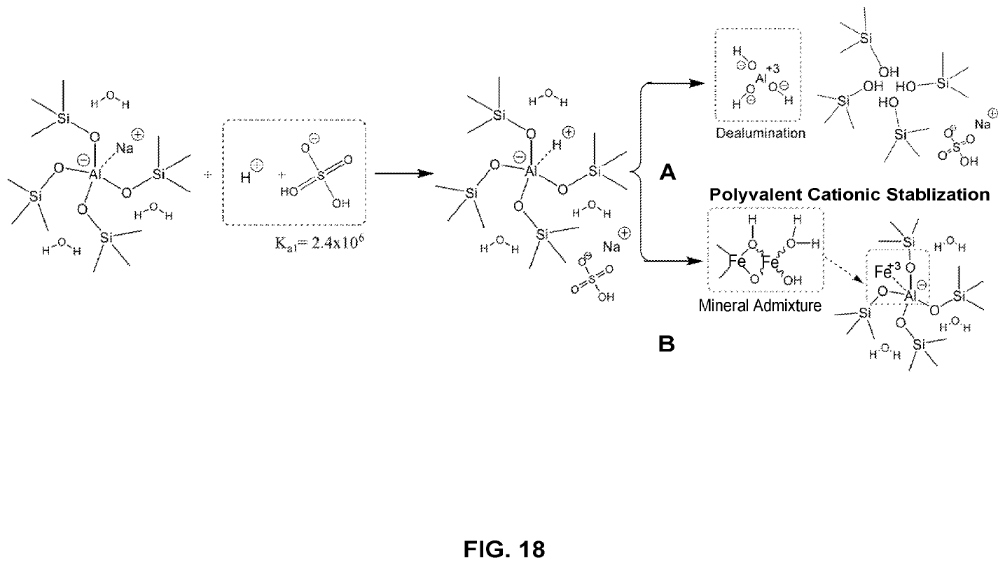

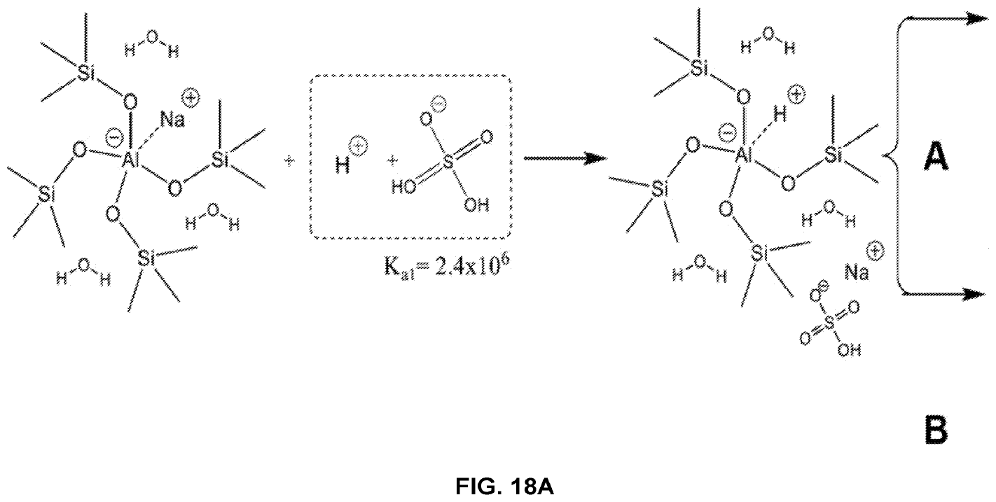

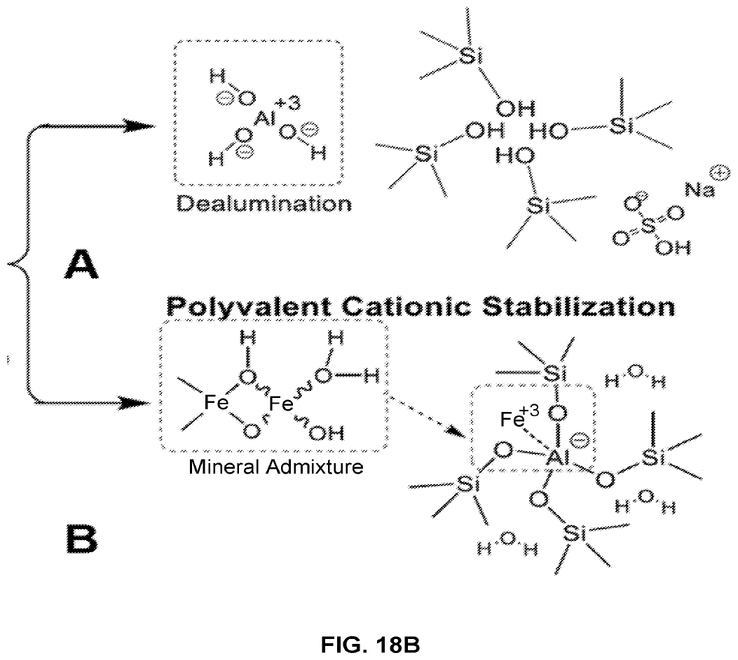

The mechanism of polyvalent cationic stabilization is summarized in FIG. 18. In light of the results presented herein, polyvalent cationic stabilization, as mechanistically illustrated in FIG. 18, could be evidenced by an increase in Fe:Al ratio within the microstructure. As previously mentioned, such an increase in Fe:Al ratio, which has been shown for the first time in this work (FIG. 17), correlates with improvements in the acid resistance of these materials. Thus, we suspect that similar polyvalent cationic stabilization processes in alkali-activated materials made from aluminosilicate precursors (e.g., slag, fly ash, lateritic clays) containing similar minerals would—depending on the type, size, speciation, and binding energy of the cations—improve the acid resistance of geopolymer (i.e., N-A-S-H) binders.

The examples above illustrate the effect of iron mineral admixtures (i.e., hematite) on material properties prior to and after sulfuric acid exposure (pH=2.00±0.07) and how resultant microstructural changes can explain the acid resistance commonly observed in alkali-activated materials. Results indicate that iron phases, such as hematite, can improve the acid resistance in high Na:Al geopolymer formulations. Improved acid resistance resulted in lower compressive strength loss due to acid attack, lower increases in observable porosity, and an arrest of the degradation of the cementitious binder.

Hematite was observed to be inert during alkali activation. Prior to acid exposure, increasing the sodium content yielded expected formation of silicon-rich mineral phases (i.e., faujasite) as well as an increase in the extent of N-A-S-H binder network formation. No evidence for Fe-induced modification of the geopolymer cementitious binder was observed. Instead, weak bonding between the cementitious binder and hematite particles resulted in lower initial compressive strength.

After acid exposure, the addition of hematite was only observed to have a beneficial effect at high alkali contents (Na:Al=1.39). Acid resistance was observed by (1) statistically insignificant loss of compressive strength, (2) minimal changes to the molecular structure (main Si—O—Al bond), (3) statistically insignificant changes to porosity, and (4) low leaching of Al (i.e., dealumination) and Si. However, these results were not obtained for samples with low alkali contents (Na:Al=0.86), most likely due to a lesser extent of highly crosslinked N-A-S-H.

The evidence collected and reported herein indicates that iron phases, such as hematite, improve the acid resistance at high Na:Al geopolymer formulations via polyvalent cationic stabilization. Stabilization prevents compressive strength loss due to acid attack, increases in porosity, and further breakdown of the cementitious binder. In this mechanism, a beneficial cationic exchange occurs in which the hydronium cations are exchanged with a stabilizing metal cation (e.g., Fe cationic specie) resembling the original alkali cation of the Si—O—Al cementitious structure, resulting in observable increases in Fe:Al content as Fe interacts with negative moieties in the Si—O—Al bonds of acid-attacked N-A-S-H cementitious binders.

### Additional Examples

The Examples below investigate the effect of alkali content (Na:Al=0.86 and 1.39) and brucite (i.e., Mg(OH)₂) mineral addition on the sulfuric acid resistance of alkali-activated metakaolin (i.e., geopolymers). Geopolymers consist primarily of a sodium-stabilized aluminosilicate hydrate (N-A-S-H) framework. The results below demonstrate that higher alkali contents and brucite addition improves the acid resistance of N-A-S-H, as evidenced by reduced dealumination and Si and Na leaching upon exposure to acid. These results can be mechanistically explained by increased retention of Mg+2 within the microstructure and increased Mg—Al interaction upon acid exposure. Higher Mg+2 retention and increased Mg—Al coupling together provide empirical evidence of polyvalent cationic stabilization—a mechanism involving polyvalent cations (e.g., Mg+2) that stabilize the N-A-S-H binder by arresting acid-induced electrophilic attack. Results further illustrate that brucite addition, especially at high-alkali content formulations, reduces micro-scale porosity while increasing the proportion of gel pores (<5 nm), which suggests that increased tortuosity of gel pores may aid in Mg+2 retention and promote the increased Mg—Al coupling observed herein.

Alkali-activation of an aluminosilicate material (e.g., metakaolin) can begin with precursor dissolution in a high-pH activator solution, which releases silica and alumina species. As the precursor dissolves, silicate and alumina species polymerize to form a cation-stabilized cementitious binder. In Ca-free AACs, the main binder comprises an amorphous N-A-S-H cementitious binder. Lower Ca contents of N-A-S-H materials have been linked to improved durability performance, namely for sulfate and seawater attack, acid exposure, alkali-silica reaction, steel corrosion, and fire.

Previous studies have shown that AACs are more resistant to acid attack than ordinary portland cement (OPC). Briefly, the acid degradation of calcium-free AACs begins with an ion-exchange between framework cations (i.e., sodium) and protons from the acid solution. The protons induce an electrophilic attack, which results in the ejection of aluminum (i.e., dealumination) from the Si—O—Al bonds of the binder.

Brucite is a common mineral present in industrial aluminosilicate precursors used in the production of AACs, such as high-magnesium and high-nickel slag and natural clays (e.g., bentonite, dolomite). Brucite can also form as a result of alkali-activation, since it is thermodynamically favorable to form under Al-deficient conditions that can exist during slag activation. Hence, due to its common presence in AACs and its solubility at low pH (i.e., acidic) conditions, it is important to understand the effect of brucite—and Mg+2 specifically—on the acid resistance of AACs. In the examples below, metakaolin was selected as the aluminosilicate precursor due to the purity of its aluminosilicate chemical composition, high reactivity, and proven ability to form N-A-S-H. By utilizing metakaolin, we consequently aim to isolate the role of Mg+2 during acid degradation of Ca-free AACs.

### Materials

Metakaolin (MK) (MetaMax) was supplied by BASF Chemical Corporation (Georgia, USA). The chemical composition of MK, as determined by ICP-OES, is shown in Table 9. The alkali-activating solution used was prepared using sodium hydroxide (Sigma-Aldrich, NaOH≥97%) and sodium silicate (Sigma-Aldrich, SiO2=27 wt %, Na2O=11 wt %). Light metal (i.e., Mg) addition to the AACs was provided in the form of brucite powder (Sigma-Aldrich, Mg(OH)2≥95%). After the AAC pastes were created, the samples were exposed to a sulfuric acid solution with a pH of 2.0±0.07. The sulfuric acid solutions were prepared by adding concentrated sulfuric acid (Sigma-Aldrich, H2SO4≥95%) to deionized water.

TABLE 9
Chemical composition of metakaolin in weight percentage (wt. %).

| (wt. %) | SiO₂ | Al₂O₃ | CaO | SO₄ | Fe₂O₃ | K₂O | Na₂O | P₂O₅ |
|---|---|---|---|---|---|---|---|---|
| Metakaolin | 54% | 47% | 0.10% | 0.30% | 0.40% | 0.10% | 0.30% | 0.10% |

### Experimental Methods

The experiments were designed using a 2² factorial design of experiments. Specific proportions and constituent materials for each mixture design formulation (see Table 10). The alkali (i.e. sodium, Na⁺) to aluminum ratio (Na:Al) was varied to produce cements with Na:Al ratios of 0.86 and 1.39. The silicon to aluminum ratio (Si:Al) was held constant at a value of 1.15. Samples were prepared without and with the addition of brucite. Brucite was added to obtain a Mg:Si ratio of 0.85, which was chosen based on previous research related to the synthesis of magnesium silicate hydrate (M-S-H) gels.

TABLE 10
Mixture proportions for metakaolin-based alkali-activated
cement control and Mg(OH)₂ addition samples.

| Sample ID | Constituent Materials | | | | | Important Parameters | | |
|---|---|---|---|---|---|---|---|---|
| Sample Name | MK (g) | Mg(OH)₂ (g) | NaSi (mL) | NaOH (g) | H₂O (ml) | Mg:Si | Si:Al | Na:Al |
| MK Control Low | 50 | 0 | 13.5 | 13 | 45 | 0 | 1.15 | 0.86 |
| MK Control High | 50 | 0 | 13.5 | 22.8 | 45 | 0 | 1.15 | 1.39 |
| Control Low + Mg | 50 | 26.4 | 13.5 | 13 | 45 | 0.85 | 1.15 | 0.86 |
| Control High + Mg | 50 | 26.4 | 13.5 | 22.8 | 45 | 0.85 | 1.15 | 1.39 |

### AAC Sample Preparation

AAC pastes were prepared using the calculated amounts of metakaolin, sodium silicate, sodium hydroxide, deionized water, and brucite (Mg(OH)₂) shown in Table 10. These components were mechanically mixed for 3 minutes before being cast in molds (diameter 2.5-2.7 cm), after which the mixtures were tamped for 30 seconds and vibrated for 30 seconds. Paste samples were then cured in sealed containers (99% RH) in a Quincy forced air laboratory oven for 48 hours at 40° C. After initial curing, samples were demolded and cured 35±5° C. for an additional 24 hours.

### Acid Exposure and Leaching

Samples were exposed to a sulfuric acid solution (pH 2.0±0.07) twice until pH equilibrium was attained, defined as ΔpH <0.0025 per hour. A modified ASTM C1308 methodology was employed to expose samples to acid. Modifications consisted of a volume-to-surface-area ratio of seven to determine the amount of acid solution to be used for each exposure. Samples were suspended using a 46 mm Savillex support screen (730-0046) and stirred continuously in an acid solution using a magnetic stirrer to ensure homogenous solution mixing. Triplicates were utilized to ensure statistical robustness of the data. After pH equilibrium, leachate samples were collected, and acid solutions were replaced. Leachate samples were analyzed via ICP-OES and ICP-MS. Leaching data were normalized by the surface area of the cylindrical samples and cement content to account for the mineral admixture supplement and facilitate a comparison between samples.

### Mineralogical Characterization

Mineralogy was determined via semi-quantitative X-ray diffraction (XRD) using Cu Kα radiation (Siemens D500 X-ray diffractometer). An internal standard (i.e., corundum, American Elements) was employed to normalize peak heights between samples and align diffraction patterns. Samples were homogenized by creating fine powders using a micronizing mill with well-packed yttrium-stabilized zirconium grinding beads. Subsequently, samples were homogenized in a plastic scintillation vial with three Delrin balls. 500 μL of Vertrel cleaning agent (Miller-Stephenson) was added to randomize particle orientation via the formation of aggregates. Lastly, samples were sieved through a 250 μm mesh and packed into XRD analysis plates. Samples were then analyzed from 5 to 65 degrees 2θ using Cu Kα X-ray radiation, with a step size of 0.02 degrees and a dwell time of 2 seconds per step. Diffraction patterns were analyzed using Jade software (MDI, Version 9) and the International Centre for Diffraction Data (ICDD) 2003 database.

### Microstructural Mg:Al Ratio Determination

Electron microprobe analysis was employed using a JEOL JXA-8230 electron probe microanalyzer outfitted with five wavelength-dispersive spectrometers (WDS) and a Thermoscientific energy dispersive spectrometer (EDS) to examine the chemical composition of the AAC microstructure, namely changes in Mg:Al ratio upon acid exposure. The acceleration voltage and beam current used for all WDS acquisition was 15 keV and 100 nA, respectively. The pixel size chosen was 6 μm, and the electron beam was adjusted to match the size. Lastly, a dwell time of 20 msec was used. The data were processed using Calclmage software (ProbeSoftware, Inc.) in order to apply the mean atomic number (MAN) background correction. EDS acquisition was standard-less using a spectral acquisition of 15 seconds, which was sufficient to accumulate counts over 4000. An acceleration voltage of 15 keV and a beam current of 20 nA was used for all acquisitions. An elemental matrix correction (ZAF) was performed in all acquisitions. Twenty randomized points were collected for five different locations in all samples (top, bottom, center, left, and right), totaling an acquisition of 100 EDS points per sample.

### Nano- and Micro-Scale Porosity Determination

Nitrogen (N₂) adsorption using a Gemini V apparatus (Micromeritics) was used to characterize nano-scale gel porosity of unexposed and acid-exposed AAC samples. Samples were prepared following the mixture proportions of Table 10, and the sample size was modified to fit tubes (diameter: 0.65 cm, height: 1.4 cm). All materials were first degassed for 24 hours in a vacuum (<100 mTorr). For specific samples, duplicate measurements were collected. Porosities and pore-size distributions were calculated using the Barrett-Joyner-Hallenda (BJH) method for unexposed samples.

In order to characterize the unexposed micro-scale porosity, samples were subjected to X-ray micro-computed tomography (μ-CT) analysis in a Zeiss Xradia 520. Samples were secured in commercial plastic vials (diameter: 2.5 cm) and scanned using a 0.4× objective and X-ray source parameters of 60 kV acceleration voltage and 4 Watts. An air filter was utilized to reduce the transmission values between 29% and 60% and maintain intensity counts above 5000 by regulating the exposure time. A pixel size resolution of 5.786 microns was achieved utilizing a bin 1 pixel averaging acquisition. Once the initial pore structure was characterized, AAC samples were exposed to acid. The post-exposure micro-scale pore structure was subsequently characterized by μ-CT scans with the same settings as those stated previously.

After μ-CT scanning, the BJH method was conducted to characterize the impact of acid exposure on the sample's nanoscale pore structure. μ-CT scans were reconstructed using the ZEISS Scout-and-Scan Control System Reconstructor (V.11.1.6411.17883) software to manually adjust the center shift values and minimize beam hardening artifacts. Prior to pore-structure segmentation, image pre-processing in Dragonfly 4.0 was used to minimize noise from acidic solutions. Denoising and smoothing were performed utilizing an Open mathematical morphology operation (circle kernel size of 7), a median smoothing (circle kernel size of 3), and a non-local means smoothing (square kernel size of 9). Such a procedure enabled consistent segmentation across all scans.

### Results and Analysis

### Physical Evidence of Sulfuric Acid Degradation

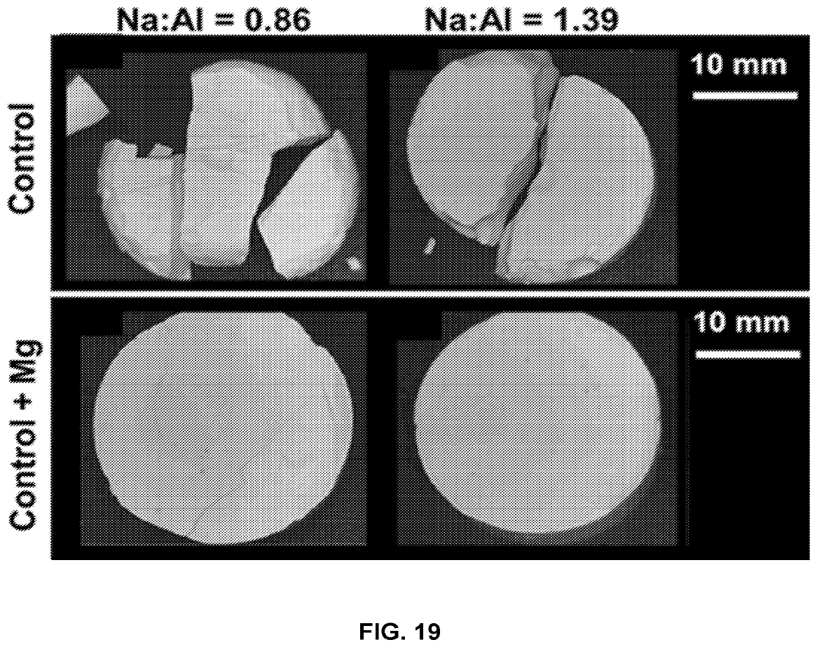

The addition of brucite visibly improved the pH ˜2 acid resistance of the AAC formulations investigated herein, as visually demonstrated in FIG. 19. Failure of control formulations without brucite addition was evident at both alkali contents, indicating a greater extent of binder breakdown by sulfuric acid attack in those samples. While structural integrity was maintained in Control Low+Mg samples, shallow surface cracks were observed, indicating some surface-level degradation. However, Control High+Mg samples maintained structural integrity and exhibited no observable cracking, suggesting that brucite addition improved the sulfuric acid resistance of the high-alkali sample.

### Chemical Evidence of Sulfuric Acid Degradation

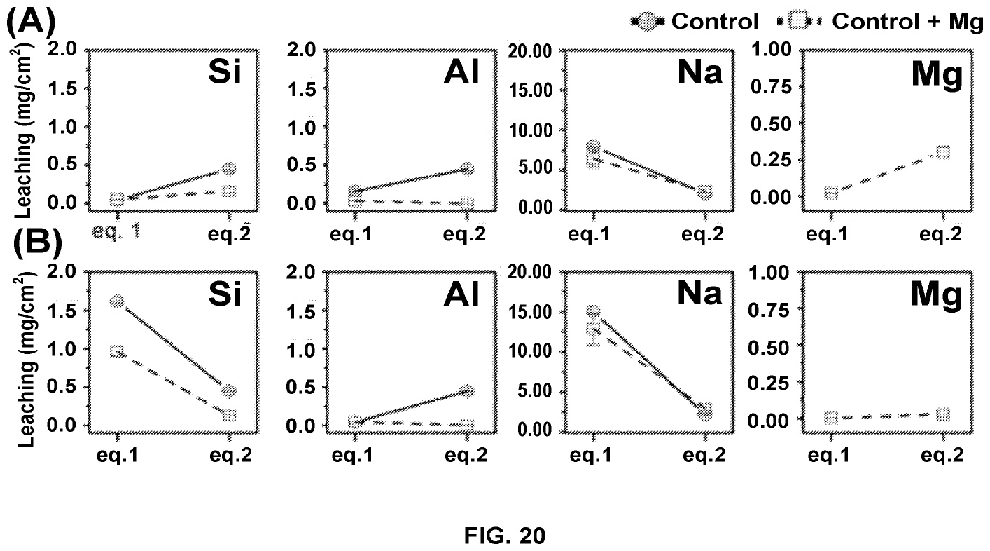

Brucite addition increased elemental silicon (Si) retention upon acid exposure, as demonstrated by a reduced loss (i.e., reduced leaching) of Si (see FIG. 20). Low Na:Al samples with brucite revealed negligible differences during the first acid exposure but a 75% decrease during the second acid exposure. Incorporation of brucite in higher Na:Al content formulations (Control High samples) decreased Si leaching 35% and 75% of during the first and second acid exposure cycles, respectively. However, the concentration of leached Si remained high in these formulations and is observed to correlate well with sodium (Na) leaching. This result can be explained by the presumed existence of Si monomers and dimers in the pore solution, which can polymerize and gelate via Na+1 stabilization. Recent studies of Na:Al=1.0 AACs have found an increased content of orthosilicic acid (i.e., Si monomers) 15 hours after alkali-activation. This increase in monomeric Si concentration enables the formation of silica gel networks within the perimeter of the sample—a well-known phenomenon of AACs.

The addition of brucite improved the acid resistance of AACs by reducing dealumination of the Si—O—Al bonds in the N-A-S-H binder. Upon first acid exposure, regardless of brucite addition or alkali content, dealumination and magnesium (Mg) leaching is minimal for both formulations that contain Mg (FIG. 20). However, upon second acid exposure, dealumination increased in samples without brucite. Increased dealumination occurs concomitantly with a decrease in Na leaching, indicating that the electrophilic attack of protons cannot be arrested solely by the alkalinity within the AAC. Contrastingly, samples containing brucite release Mg, indicating that the dissolution of brucite aids in increasing the alkalinity (i.e., pH buffering capacity) of these formulations. High Na:Al samples with brucite are observed to retain dissolved Mg and simultaneously exhibit lower dealumination. These results chemically support the physical evidence observed in FIG. 19 that brucite improves the acid resistance of AACs, especially at high alkali contents.

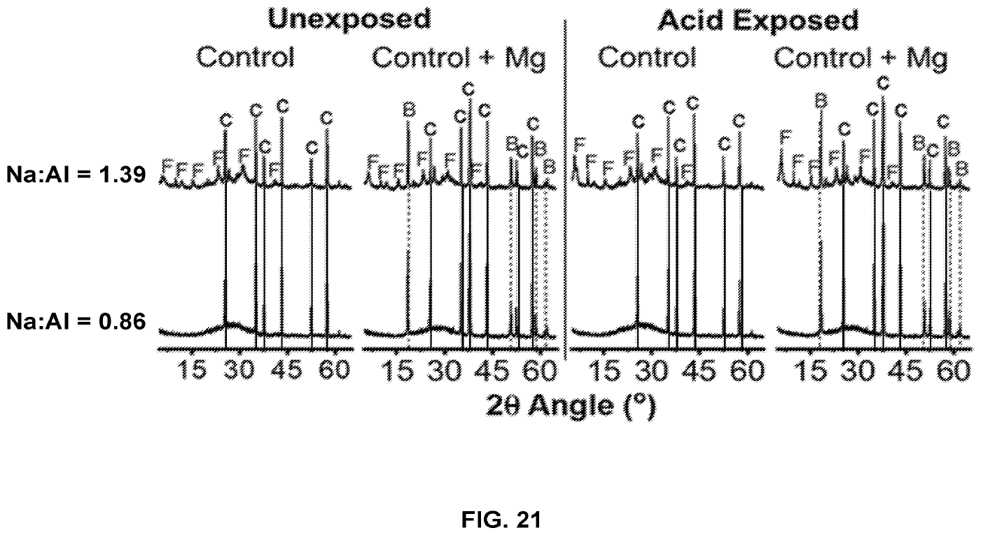

Mineralogies of Control and Control+Mg samples before and after acid exposure remain unchanged between formulations (see FIG. 21), indicating that no significant precipitation reactions occurred during acid exposure. All samples indicate a predominantly amorphous component, identified by a hump ˜25° 2θ angles. This amorphous component is indicative of N-A-S-H. Silicon-rich faujasite minerals (Na2.06Al2Si3.8O11.63.8H) form in high sodium content (Na:Al=1.39) formulations, regardless of brucite addition, as expected. Upon acid exposure, minimal changes in the mineralogy of AACs are observed. High Na:Al samples demonstrated an increased diffraction intensity of faujasite after acid exposure, possibly indicating further mineralization during acid exposure. Similar mineralization reactions after acidic exposure were also correlated to reduced porosity and increased mechanical performance. Thus, these results indicate that acid degradation of these Ca-free AACs does not involve significant precipitation reactions as observabe in Ca-rich cementitious materials, which form gypsiferous (e.g., CaSO₄.2H₂O) phases upon exposure to sulfuric acid.

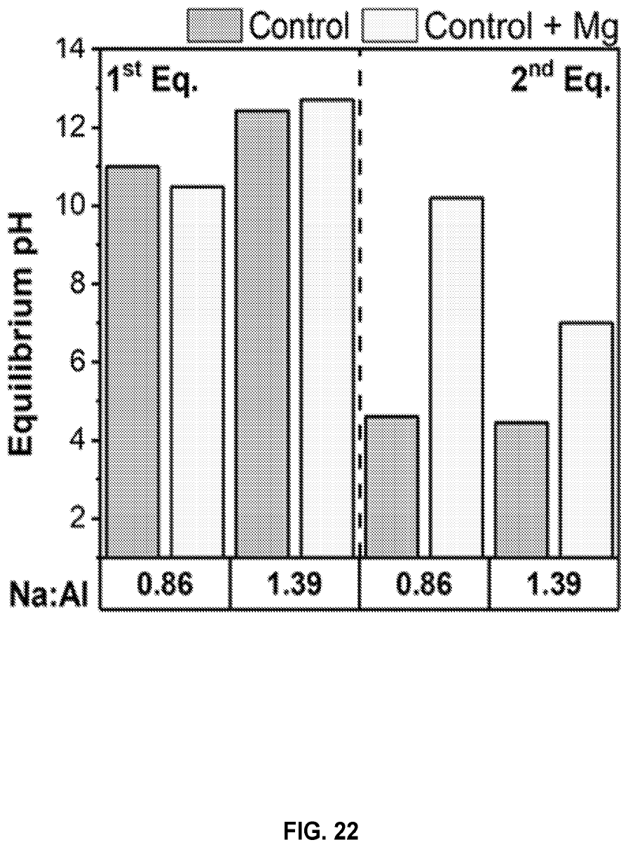

The acid neutralization capacity of AACs increases with the addition of brucite during the second acid exposure (FIG. 22). Brucite-supplemented samples attained a higher equilibrium pH values indicating a higher acid neutralization capacity than their control counterparts. During the first acid exposure, regardless of alkali content, equilibrium pH values of all samples are not statistically different (p-value of 0.517). pH values are highly correlated with an increase in Na+ leaching during the first acid exposure. The correlation was verified by computing the Pearson correlation coefficient, which yielded a value of 0.938 (p-value of 0.0001). This correlation is expected, given that an inter-cationic exchange between H+ and Na+ occurs during the first step of acid degradation of N-A-S-H. Also, the acid-base reaction of trace carbonates and hydroxides in the pore solution (e.g., Na2CO3, NaOH) may contribute to this leaching correlation. However, the presence of these phases in the pore solution is speculated as XRD was unable to resolve distinct patterns in the solid phase of these materials (FIG. 21). Remnant NaOH is evidenced by high equilibrium pHs (i.e., 12.4, 12.7) attained in high Na-content formulations (Na:Al=1.39). However, during the second acid exposure, samples without brucite demonstrated a low acid neutralization capacity, achieving equilibrium pHs <4.6. The addition of brucite improves acid neutralization capacity. Control Low+Mg and Control High+Mg samples reach pH values of 10.2 and 7.0, respectively, during the second acid exposure.

It is worth noting that, while Control High+Mg samples attain lower pH equilibrium conditions, these samples also demonstrate high Mg retention (FIG. 21), which indicates differences in acid-base reactions occurring in the samples. In order to explain the differences in the acid-base reactions occurring in the pastes, a microstructural chemical analysis was performed. More specifically, Mg:Al ratios of the pastes were determined before and after exposure to acid. While Control Low+Mg formulations exhibited higher acid acid neutralization capacity, Control High+Mg samples were evidently more acid resistant.

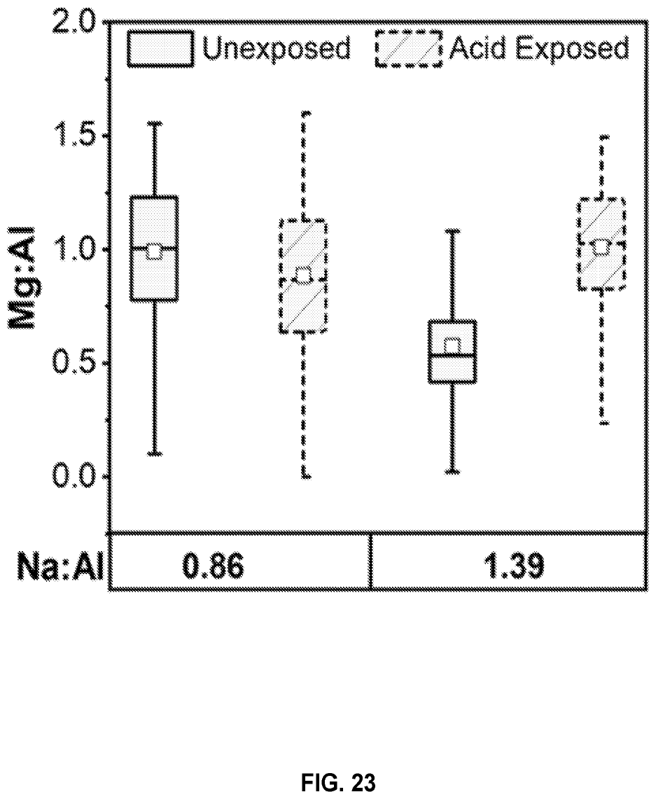

The high Na:Al samples with brucite exhibit a two-fold increase in Mg:Al ratio within their microstructures after the second acid exposure (FIG. 23). The increase of Mg and Al spatial pairing is likely a result of Mg stabilization of negative moieties along with the acid-attacked Si—O—Al bonds — a process name polyvalent cationic stabilization. Contrastingly, Control Low+Mg samples demonstrate lower Mg:Al ratios after acid exposure a consequence of high Mg leaching (FIG. 20). This observed leaching of alkalis (e.g., Na, Mg, K, Ca) is a common phenomenon.

Polyvalent cationic stabilization of negative moieties in the N-A-S-H binder can occur due to functionalized brucite surfaces or release of Mg+2 cations. Seminal research on Brucite (Mg(OH₂)) surface chemistry has shown that the protonation of the mineral surface (>Mg—OH) yields >MgOH2+ sites, which are at a maximum concentration on brucite surfaces at pH values <7.0. As observed in FIG. 22, the final equilibrium pH of Control High+Mg samples is 7.0, which may enable dipole-dipole interactions between >MgOH2+ and negative moieties of the surrounding N-A-S-H binder. Additionally, >MgOH2+ surface sites also enable the dissolution and release of Mg+2 ions, according to the thermodynamically preferred dissolution reaction (pK −16.844):

Mg(OH)₂+2H+→Mg+2+2H₂O

Lastly, the small atomic radii of Mg+2 ions is advantageous in terms of its mobility, which would facilitate leaching. However, results presented here demonstrate higher retention of Mg+2 due to Mg—Al interactions in the high Na:Al samples with brucite. Thus, it is evident that a higher number of Mg—Al interactions within the AAC microstructure yield improved acid resistance with a lower breakdown of the Si—O—Al bonds of N-A-S-H binders.

### Porosity of AlkaliActivated Cements Supplemented With Brucite

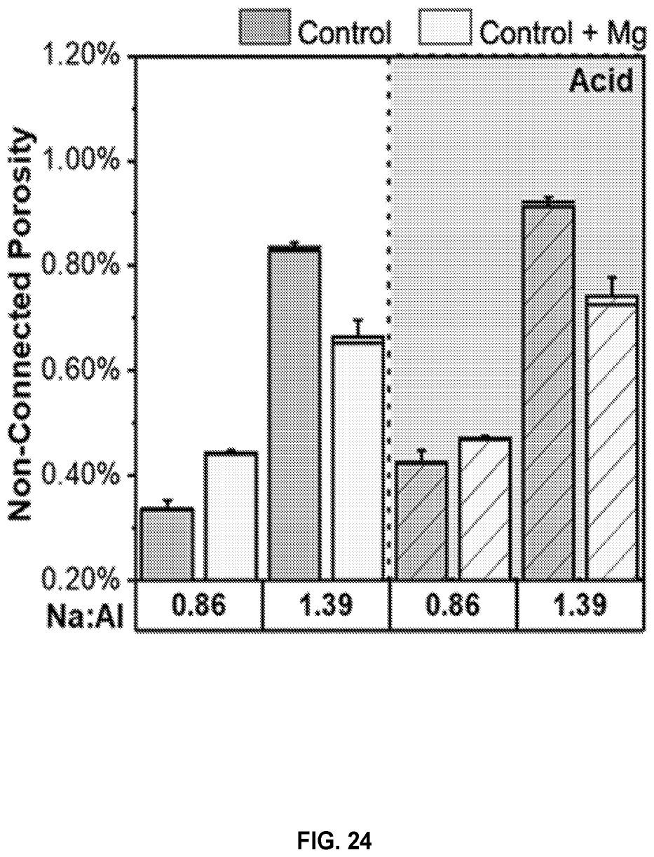

Micro-scale porosities of samples before and after acid exposure are shown FIG. 24. Non-connected porosities between 0.3%48% are comparable to those reported by X-ray microtomography (μCT) studies of other fly ash-based AACs. Results in FIG. 24 demonstrate that the addition of brucite at high Na:Al formulations decrease by 18% the porosity of AACs, while the opposite effect is observed at low Na:Al formulations containing brucite demonstrating a 26% porosity increase.

As observed in FIG. 24, increased alkali-content results in higher porosity values as observed for Control High formulations. This is a dissimilar trend reported in other AAC literature, where increased Na content is expected to decrease porosity due to an increased formation of reaction products and a denser microstructure. Observed porosity differences, although minor, may be explained by utilization of activating solutions with low silica modulus (Ms) values (Ms=0.27) at high Na:Al formulations. These activating solutions have higher viscosities due to higher contents of dissolved Na and Si ions and, hence, an increase of porosity is anticipated as a consequence of entrapped air during mixing. This likely results in decreased compressive strength, due to a lower bulk density associated with higher porosities in less workable mixes.

Regardless of brucite addition, AACs develop higher micro-scale porosities during the first acid exposure. The addition of brucite reduces the increase in porosity for both Control Low and Control High formulations by 50.9% and 14.1%, respectively. These results correlate well with the lower Na and Si leaching of these samples (FIG. 20). The expected Si gelation and retention of Na ions likely plays a role in decreasing the changes in porosity at the micro-scale of brucite-supplemented AACs. Moreover, results suggest that the preservation of the pore structure in Control Low+Mg samples correlates with reduced dealumination. In light of the Mg:Al results shown in FIG. 23, as well as leaching results presented in FIG. 20, Control High+Mg samples may preserve their porous structure as a result of Mg—Al stabilization. The formation of crystalline faujasite phases during acid attack, as discussed in connection with FIG. 21, may also play a role in pore-structure preservation.

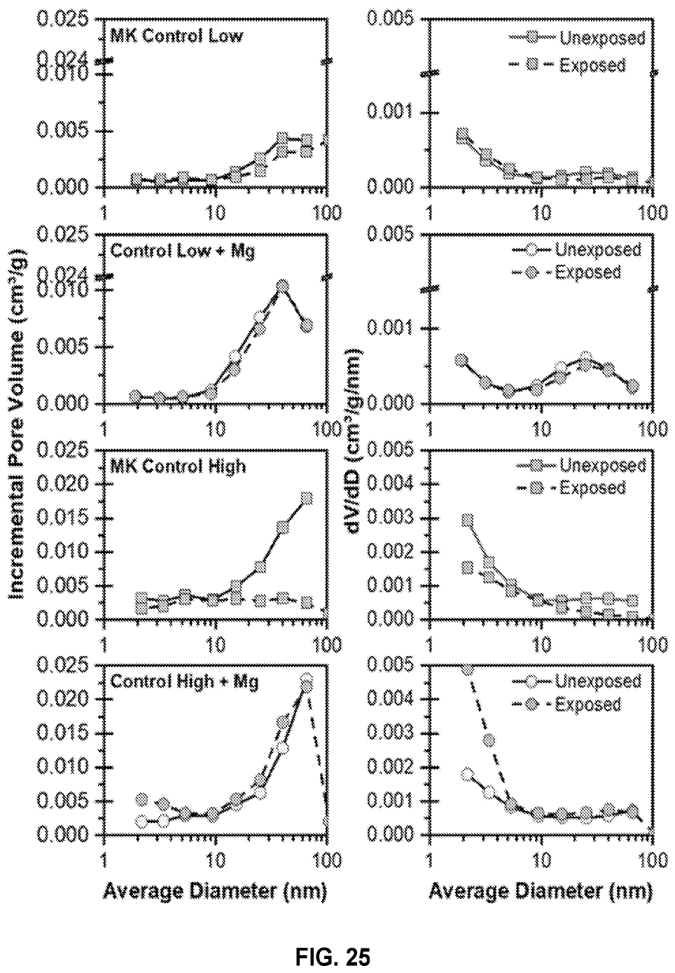

Addition of brucite in low Na:Al formulations is observed to double the gel pore volumes above a pore size of 10 nm (FIG. 25). In general, the opposite trend is observed at high Na:Al formulations with brucite (Control High+Mg) as these exhibit a ˜30% lower nano-scale porosity when compared to samples without brucite. Moreover, when analyzing the effect of alkali content, Control High formulations have a higher content of nano-scale porosity, when compared to Control Low. These nano-scale porosity trends are consistent with the micro-scale porosity trends observed in FIG. 24. Increased micro- and nano-scale porosity at higher sodium contents may be due to residual inter-layer porosity from unreacted MK precursor, as well as rheology differences due to extent of binder network formation, as previously discussed.

Upon acid exposure, there is an apparent decrease in incremental pore volume in samples without brucite, see FIG. 25. Given the utilization of BJH, the apparent decrease in nano-scale pore volume may actually be a consequence of acidic dissolution, which may create larger pores (>100 nm) outside of the method's pore size range. This result is supported by a higher extent of Si—O—Al breakdown as shown by high leaching of Na, Si, and Al (FIG. 20) as well as the increased micro-scale porosity (FIG. 24).

Nonetheless, it is evident that the addition of brucite preserves nano-scale porosity. Interestingly, only Control High formulations with brucite double in nano-scale porosity (<5 nm), which may increase the tortuosity of porous network and, hence, increase the dissolution of brucite. Similar observable increases in tortuosity have been reported in previous experiments with chemically-active mineral admixtures. As Mg+2 ions are liberated from the acid-induced dissolution of brucite, the higher tortuosity may increase the probability of Mg+2 encountering negative moieties along the acid-attack N-A-S-H binder. This phenomenon would also explain the higher Mg retention (FIG. 20) and concomitant lower acid neutralization capacity (FIG. 22), which would lead to increased Mg—Al pairing within the microstructure (FIG. 23). Together, these results indicate that the increase in tortuosity caused by an increase in nano-scale gel pores after acid exposure may be important to the effectiveness of the polyvalent cationic stabilization mechanism.

Converging lines of evidence suggest that brucite improves acid resistance by (1) increasing acid neutralization capacity and/or (2) polyvalent cationic stabilization, depending on AAC formulation.

Experimental data indicate that brucite increases acid resistance in AACs with low alkali contents (Na:Al=0.86) by increasing acid neutralization capacity alone. Low Na:Al AACs with brucite exhibit a high acid neutralization capacity, with equilibrium pH values reaching >10 after the first and second acid exposure. This neutralization, in turn, resulted in decreased loss of Al, Si, and Na upon acid exposure, indicating a reduced breakdown of Si—O—Al. The decreased leaching of Al, Si, and Na also correlated with minimal changes to micro-scale preservation of nano-scale porosity (1-100 nm). However, no significant changes in Mg—Al pairing were observed in these samples and, as a result, polyvalent cationic stabilization was not evidenced in these samples.

Experimental data also indicate that brucite improves acid resistance in AACs with high alkali (Na:Al=1.39) contents by increasing acid neutralization capacity and polyvalent cationic stabilization. Upon acid exposure, addition of brucite improved acid resistance, as evidenced by lower Al, Si, and Na leaching and increases in acid neutralization capacity compared samples without brucite. However, the acid neutralization capacity was dependent on Mg leaching and, during the second acid exposure, Mg was retained within the material's microstructure. This retention lead to a decrease in the acid neutralization capacity and a concomitant increase in Mg—Al interactions, as evinced via electron microprobe analysis. Results also demonstrate that, while the nano-scale porous structure was preserved in these samples, there was an increase in pore sizes <5 nm. Increased nano-scale porosity likely increased the tortuosity and brucite dissolution, which supports the increase in Mg—Al pairing observed. Together, these results provide evidence in support of polyvalent cationic stabilization as a unique acid resistance mechanism that preserves the integrity of aluminosilicate binders upon exposure to acid.

### Additional Examples

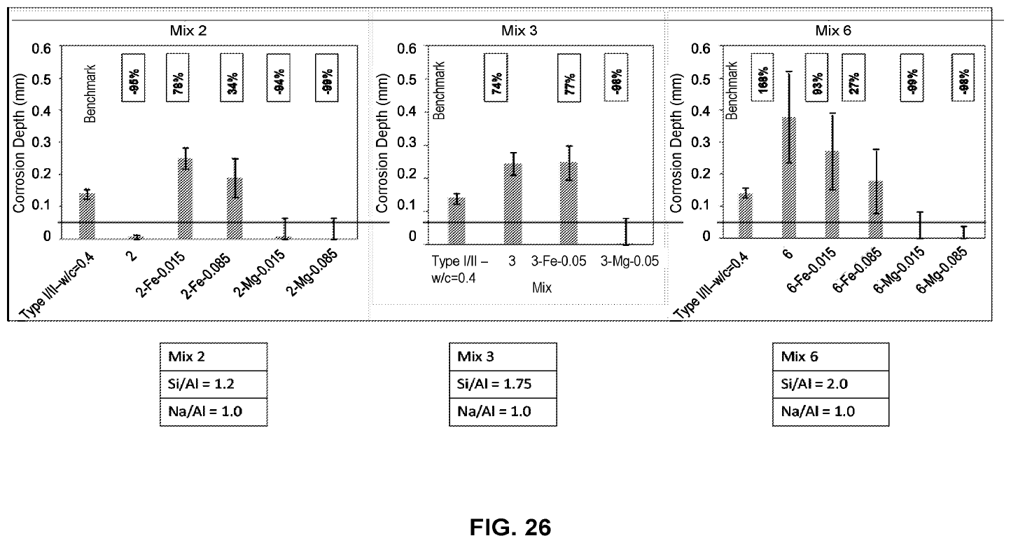

Table 11 below illustrates exemplary geopolymer compositions in accordance with further examples of the disclosure. Table 12 illustrates various compositions with added iron, table 13 illustrates compositions with added magnesium, table 14 illustrates compositions with added titanium, and table 15 illustrates compositions with added calcium. FIG. 26 illustrates acid resistance for various compositions set forth in tables 11-15 for mixes 2, 3, and 6. Compositions with acid resistance below the line in FIG. 26 illustrate compositions with improved acid resistance.

TABLE 11
Exemplary compositions

| | | | Mix design Na₂O:Al₂O₃:SiO₂:H₂O | | | |
|---|---|---|---|---|---|---|
| Mix | Si/Al | Na/Al | Na₂O | Al₂O₃ | SiO₂ | H₂O |
| 1 | 1.027 | 1.0 | 1 | 1 | 2.05 | 11 |
| 2 | 1.5 | 1.0 | 1 | 1 | 3 | 11 |
| 3 | 1.75 | 1.0 | 1 | 1 | 3.5 | 11 |
| 4 | 2.0 | 0.8 | 0.8 | 1 | 4 | 11 |
| 5 | 2.0 | 1.0 | 1 | 1 | 4 | 11 |
| 6 | 2.0 | 1.2 | 1.2 | 1 | 4 | 11 |

TABLE 12
Compositions 2, 3, and 6 with added iron
Fe³⁺ cation

| Mix | Si/Al | Na/Al | Cation | (Fe/Al) |
|---|---|---|---|---|
| 2-Fe-0.015 | 1.5 | 1.0 | Fe³⁺ (Hematite) | 0.015 |
| 2-Fe-0.085 | 1.5 | 1.0 | Fe³⁺ (Hematite) | 0.085 |
| 3-Fe-0.05 | 1.75 | 1.0 | Fe³⁺ (Hematite) | 0.05 |
| 6-Fe-0.015 | 2.0 | 1.0 | Fe³⁺ (Hematite) | 0.015 |
| 6-Fe-0.085 | 2.0 | 1.0 | Fe³⁺ (Hematite) | 0.085 |

TABLE 13
Compositions 2, 3, and 6 with added magnesium
Mg²⁺ cation

| Mix | Si/Al | Na/Al | Cation | (Mg/Al) |
|---|---|---|---|---|
| 2-Mg-0.015 | 1.5 | 1.0 | Mg2⁺ (Brucite) | 0.015 |
| 2-Mg-0.085 | 1.5 | 1.0 | Mg2⁺ (Brucite) | 0.085 |
| 3- Mg-0.05 | 1.75 | 1.0 | Mg2⁺ (Brucite) | 0.05 |
| 6- Mg-0.015 | 2.0 | 1.0 | Mg2⁺ (Brucite) | 0.015 |
| 6- Mg-0.085 | 2.0 | 1.0 | Mg2⁺ (Brucite) | 0.085 |

TABLE 14
Compositions 2, 3, and 6 with added titanium
Ti⁴⁺ cation

| Mix | Si/Al | Na/Al | Cation | (Ti/Al) |
|---|---|---|---|---|
| 2-Ti-0.015 | 1.5 | 1.0 | Ti⁴⁺ (Rutile) | 0.015 |
| 2-Ti-0.085 | 1.5 | 1.0 | Ti⁴⁺ (Rutile) | 0.085 |
| 3-Ti-0.05 | 1.75 | 1.0 | Ti⁴⁺ (Rutile) | 0.05 |
| 6-Ti-0.015 | 2.0 | 1.0 | Ti⁴⁺ (Rutile) | 0.015 |
| 6-Ti-0.085 | 2.0 | 1.0 | Ti⁴⁺ (Rutile) | 0.085 |

TABLE 15
Compositions 2, 3, and 6 with added iron calcium
Ca²⁺ cation

| Mix | Si/Al | Na/Al | Cation | (Ca/Al) |
|---|---|---|---|---|
| 2-Ca-0.015 | 1.5 | 1.0 | Ca²⁺ (Portlandite) | 0.015 |
| 3- Ca-0.05 | 1.75 | 1.0 | Ca²⁺ (Portlandite) | 0.05 |
| 3- Ca-0.085 | 1.75 | 1.0 | Ca²⁺ (Portlandite) | 0.085 |
| 6- Ca-0.015 | 2.0 | 1.0 | Ca²⁺ (Portlandite) | 0.015 |
| 6- Ca-0.085 | 2.0 | 1.0 | Ca²⁺ (Portlandite) | 0.085 |

The example embodiments of the disclosure described above do not limit the scope of the invention, since these embodiments are merely examples of the embodiments of the invention. Any equivalent embodiments are intended to be within the scope of this invention. Indeed, various modifications of the disclosure, in addition to the embodiments shown and described herein, such as alternative useful combinations of the elements described, may become apparent to those skilled in the art from the description. Such modifications and embodiments are also intended to fall within the scope of the appended claims.

1. An acid-resistant composite material comprising:
greater than 0% to about 75% or about 40% to about 60% SiO₂;
greater than 0% to about 75% or about 30% to about 50% Al₂O₃;
about 1% to about 25% or about 1% to about 20% CaO;
greater than 0% to about 25%, or about 0.1% to about 10%, or about 1% to about 10% one or more monovalent, divalent, or polyvalent cationic metals; and
greater than 0% to about 25%, or about 0.1% to about 10%, or about 1% to about 10% one or more other inorganic materials.

2. The acid-resistant composite material of claim 1, wherein the one or more monovalent, divalent, or polyvalent cationic metals comprise one or more transition metals.

3. The acid-resistant composite material of claim 1, wherein the one or more monovalent, divalent, or polyvalent cationic metals comprise one or more group 2 or group 8-11 metals.

4. The acid-resistant composite material of claim 1, wherein the one or more monovalent, divalent, or polyvalent cationic metals comprise one or more metals selected from the group consisting of titanium, lithium, chromium, calcium, copper, cobalt, iron, and magnesium.

5. The acid-resistant composite material of claim 1, comprising a plurality of the metals.

6. The acid-resistant composite material of claim 1, wherein a ratio of silicon to aluminum in the acid-resistant composite material is about 0.75 to about 3.0.

7. The acid-resistant composite material of claim 1, wherein a ratio of sodium to aluminum in the acid-resistant composite material is about 0.8, or about 0.9 to about 1.4.

8. A method of forming an acid-resistant composite material, the method comprising the steps of:
dissolving one or more alkaline metal salts in a solution; and
adding the solution to one or more aluminosilicate precursors and optionally other minerals to form a mixture.

9. The method of forming an acid-resistant composite material of claim 8, wherein the one or more aluminosilicate precursors comprise a synthetic aluminosilicate precursor.

10. The method of forming an acid-resistant composite material of claim 8, wherein the one or more aluminosilicate precursors comprise one or more of Metakaolin, fly ash, slag, pumice, basalt, glass, or other natural pozzolan.

11. The method of forming an acid-resistant composite material of claim 8, further comprising a step of filtering the mixture.

12. The method of forming an acid-resistant composite material of claim 8, further comprising a step of drying the mixture to form a dried material.

13. The method of forming an acid-resistant composite material of claim 12, further comprising a step of grinding the dried material.

14. The method of forming an acid-resistant composite material of claim 8, further comprising adding an alkali additive to one or more of the mixture and the dried material.

15. The method of forming an acid-resistant composite material of claim 14, wherein the alkali additive comprises one of more of sodium silicate, sodium hydroxide, potassium hydroxide, or sodium carbonate.

16. The method of forming an acid-resistant composite material of claim 14, wherein the step of adding an alkali additive to one or more of the mixture and the dried material comprises adding a solid and/or a liquid.

17. The method of forming an acid-resistant composite material of claim 14, wherein the step of adding an alkali additive to one or more of the mixture and the dried material comprises adding a solid.

18. The method of forming an acid-resistant composite material of claim 14, wherein the step of adding an alkali additive to one or more of the mixture and the dried material comprises adding a liquid.
